(19) United States
(12) Patent Application Publication
(10) Pub. No.: US 2022/0306501 A1
(43) Pub. Date: Sep. 29, 2022

(54) MICROBIAL ELECTROCHEMICAL ELECTRODES

(71) Applicant: ARIEL SCIENTIFIC INNOVATIONS LTD., Ariel (IL)

(72) Inventors: Rivka CAHAN, Petah Tiqwa (IL); Alex SCHECHTER, Givat Koach (IL); Shmuel ROZENFELD, Petah Tiqwa (IL); Lea OUAKNIN-HIRSCH, Yad Binyamin (IL); Bharath GANDU, Ariel (IL)

(21) Appl. No.: 17/639,413

(22) PCT Filed: Sep. 1, 2020
(86) PCT No.: PCT/IL2020/050950

§ 371 Date: Mar. 1, 2022

Related U.S. Application Data
(60) Provisional application No. 62/894,808, filed on Sep. 1, 2019.

(51) Int. Cl. C02F 3/00

(52) U.S. Cl. CPC C02F 3/005; C02F 2001/46133

(57) ABSTRACT

The present invention is directed to an anode including bacteria, a polymer, and a conductive material, wherein the bacteria, the polymer and the conductive material are deposited on at least one surface of the anode. Further provided is a microbial electrochemical system comprising the herein disclosed anode, and methods of using the same, such as for treating wastewater, hydrogen production, or generating electricity.

### CROSS REFERENCE TO RELATED APPLICATIONS

This application claims the benefit of priority to U.S. Provisional Patent Application No. 62/894,808 filed Sep. 1, 2019, entitled “MICROBIAL ELECTROCHEMICAL ELECTRODES” the contents of which are incorporated herein by reference in their entirety.

### FIELD OF THE INVENTION

The present invention is in the field of microbial fuel cells.

### BACKGROUND OF THE INVENTION

Microbial electrochemical systems (MESs) have been extensively investigated in the past decade, due to their great potential for use in wastewater treatment and energy recovery applications. MESs can be broadly classified either as a microbial fuel cell (MFC) or a microbial electrolysis cell (MEC).

While development of these devices holds great promise for progress towards new energy technologies, certain applications are limited. The performance of a MES strongly relies on the activity and efficacy of the bacterial anode, which is considered the limiting element. The anode properties require a high surface area for electrogenic biofilm formation, functional groups that will support the sustainable attachment of the bacteria to the surface, and high conductivity to support effective electron transfer from the bacteria to the anode material.

To date, there are no effective methods in the literature which show to actively protect and promote the electrogenic biofilm. Thus, there is a continuing need for development of methods and effective formulations for microbial fuel cells.

### SUMMARY OF THE INVENTION

According to one aspect, there is provided an anode comprising (i) a conductive material; (ii) a bacteria; and (iii) a polymer, a catalyst, a mineral, or any combination thereof, wherein the bacteria and the polymer, the catalyst, the mineral, or any combination thereof, are deposited on at least one surface of the anode.

In some embodiments, the anode comprises (i) a conductive material, (ii) a bacteria and (iii) a polymer and a catalyst.

In some embodiments, the anode comprises (i) a conductive material, (ii) a bacteria and (iii) a mineral.

In some embodiments, the anode comprises (i) a conductive material, (ii) a bacteria and (iii) a polymer and a mineral.

In some embodiments, the anode comprises 0.1 mg/cm² to 10 mg/cm² of the catalyst.

In some embodiments, the catalyst comprises iron, manganese, vanadium, chromium, tungsten, tin, lead, bismuth, copper, nickel, silver, gold, titanium, platinum, palladium, iridium, ruthenium, molybdenum and their oxides, carbides, sulfides, selenides, phosphides, or any combination thereof.

In some embodiments, the anode comprises 0.5 g to 5 g of the mineral.

In some embodiments, the mineral comprises Kaolin, Smectite, Chlorite, Halloysite, Dickite, Montmorillonite Magnetite, Ilmenite, Hematite, or any combination thereof.

In some embodiments, the anode comprises a permeable mesh as an outer layer.

In some embodiments, the permeable mesh is selected from the group consisting of: polyamide, cellulose, cellulose ester, polysulfone, polyethersulfone (PES), etched polycarbonate, and collagen.

In some embodiments, the ratio of the polymer and the conductive material is 0.1:1 to 1:0.1.

In some embodiments, the bacteria is an exoelectrogenic bacteria selected from Geobacteraceae, Aeromonadaceae, Alteromonadaceae, Clostridiaceae, Comamonadaceae, Desulfuromonaceae, Enterobacteriaceae, Pasturellaceae, and Pseudomonadaceae.

In some embodiments, the polymer comprises alginate, chitosan, agarose, kaolin, polyvinyl pyridine, poly ethers, poly vinyl alcohol, or any combination thereof.

In some embodiments, the polymer comprises alginate and chitosan at a ratio of 0.1:1 to 1:0.1.

In some embodiments, the conductive material comprises a redox polymer, carbon nanotube (CNT), graphene, activated carbon, carbon paper, carbon cloth, carbon felt, carbon wool, carbon foam, graphite, porous graphite, graphite powder, graphite granules, graphite fiber, a conductive polymer, metal, metal-porpherine, metal-corolles, metal-selens, quinone, organic dye, and any combination thereof.

According to another aspect, there is provided a microbial electrochemical system comprising the herein disclosed anode, and a cathode.

In some embodiments, the microbial electrochemical system comprises a semi-single-chamber, single-chamber or a dual chamber.

In some embodiments, the microbial electrochemical system is for use in wastewater (WW) treatment, electricity generation, hydrogen production, or any combination thereof.

In some embodiments, the microbial electrochemical system is characterized by hydrogen evolution reaction (HER) rate in the range of 0.1 m³·m⁻³·d⁻¹ to 5 m³·m⁻³·d⁻¹.

In some embodiments, the microbial electrochemical system is characterized by chemical oxygen demand (COD) removal in the range of 70% to 90%.

In some embodiments, the microbial electrochemical system is characterized by current density in the range of 2 A·m⁻² to 30 A·m⁻².

According to another aspect, there is provided a method comprising: (a) providing the herein disclosed microbial electrochemical system; (b) contacting the microbial electrochemical system with a carbon source; and (c) providing an electrical current to the microbial electrochemical system.

In some embodiments, the method is for WW treatment, hydrogen production, electricity generation, or any combination thereof.

In some embodiments, the carbon source comprises wastewater, acetate, or a combination thereof.

In some embodiments, the carbon source comprises acetate and wastewater at a ratio of 5:1 to 0.5:1.

In some embodiments, the method is characterized by a COD of 800 mg/L to 1000 mg/L.

In some embodiments, the microbial electrochemical system is characterized by a HER rate in the range of 0.1 m³·m⁻³·d⁻¹ to 5 m³·m⁻³·d⁻¹.

In some embodiments, the microbial electrochemical system is characterized by COD removal of 70% to 90%.

In some embodiments, the microbial electrochemical system is characterized by current density in the range of 2 A·m⁻² to 30 A·m⁻².

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Further embodiments and the full scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

In addition to the exemplary aspects and embodiments described above, further aspects and embodiments will become apparent by reference to the figures and by study of the following detailed description.

### BRIEF DESCRIPTION OF THE DRAWINGS

FIGS. 1A-1B present the comparison of electrochemical activity of MECs applying an immobilized anode inoculated with 1 OD and 0.1 OD at 590 nm; DPV measurement of oxidation currents under 14 steps of applied voltages, from −0.5V to 0.8V vs. Ag/AgCl (each step lasted 300 seconds, with detected step values occurring on average in the last 50 seconds) (FIG. 1A); and steady-state polarization (LSV, 5 mV s-¹) (FIG. 1B); MEC: based on the AC-1 (line) and AC-0.1 (dashed line) bacterial anode in a single-cell MEC;

FIGS. 2A-2B present graphs of DPV measurements of oxidation (300 s each step) in MECs based on the different anodes: AC-1 (circle), A-1 (square) and non-immobilized anode (diamond) with acetate (FIG. 2A) and wastewater (FIG. 2B);

FIGS. 3A-3B present graphs of LSV polarization curves for a cathode in a single-cell MEC based on AC-1 (line), A-1 (dot dashed line) and non-immobilized (rectangle dashed line) bacterial anodes with acetate (FIG. 3A) and WW (FIG. 3B) as the carbon source. Scan rate was 5 mV s⁻¹;

FIG. 4 presents temporal profiles of the current outputs delivered by MECs based on the immobilized anodes: AC-1, A-1 and the non-immobilized anode. The arrows indicate the addition of a carbon source;

FIG. 5 presents COD removal pattern with MECs based on different anodes: AC-1, A-1 and the non-immobilized anode;

FIG. 6 presents microbial diversity analysis with respect to genus;

FIGS. 7A-7F present SEM Micrographs: Non-immobilized anode (FIGS. 7A-7B), A-1 (FIGS. 7C-7D) and AC-1 (FIGS. 7E-7F) bacterial anodes. Magnification: 150× (left) and 1,000× (right);

FIG. 8 presents LSV polarization curves for a bacterial anode made of carbon cloth plasma treated (CCP), stainless steel (SS) and a combination of CCP and SS (COMBP) to compare a dialysis (D) active D-CCP, D-SS and D-COMBP anodes in a single-cell MEC containing Geobacter medium and 0.1 M PB, pH 7. Scan rate was 5 mV s⁻¹ versus Ag/AgCl;

FIG. 9 presents LSV polarization curves for a COMBP bioanodes in dialysis enclosing with several MWCO cut off sizes: D2-COMBP, D14-COMBP and D50-COMBP, compared to non-dialysis COMBP in a single-cell MEC containing G. sulfurreducens in Geobacter medium and 0.1 M PB, pH 7. Potentials from −0.5V to 0.8V vs. Ag/AgCl. Scan rate was 5 mV s⁻¹;

FIG. 10 presents LSV polarization curves for a cathode in a MEC based on anodes made of dialysis growth treated D2-COMBP, D14-COMBP and D50-COMBP, compared to non-dialysis COMBP in a single-cell MEC containing G. sulfurreducens in Geobacter medium and 0.1 M PB, pH 7. Cell potentials from 0V to 1V. Scan rate was 5 mV s⁻¹;

FIG. 11 presents LSV polarization curves of COMBP, to compare a dialysis active D-COMBP anode in a single-cell MEC containing Geobacter medium and 0.1 M PB, pH7. Scan rate was 5 mV s⁻¹ versus Ag/AgCl;

FIGS. 12A-12B present MTT analysis of biofilm viability on dialysis enclosed bioanodes D2-COMBP, D14-COMBP, D50-COMBP and non-dialysis COMBP bioanode as a control, after MEC operation, per 1 cm² anode (FIG. 12A) under acetate feeding (FIG. 12B) under WW feeding;

FIG. 13 presents relative abundance of anodic microbial community 16S rRNA sequences. (A) biofilm community of dialysis enclosing anode under acetate as carbon source; (B) biofilm community of dialysis enclosing anode under wastewater as carbon source; (C) planktonic community of dialysis enclosing anode under wastewater as carbon source; (D) biofilm community of non-dialysis anode under acetate as carbon source; (E) biofilm community of non-dialysis anode under wastewater as carbon source; (F) planktonic community of non-dialysis anode under wastewater as carbon source;

FIG. 14 presents a schematic representation of an non-limiting exemplary experimental setup, a semi-single-chamber MEC according to the present invention: anode material encapsulated in a dialysis bag (A), carbon-cloth cathode coated with Pt (B), and Ag/AgCl reference electrode (C);

FIG. 15 presents LSV polarization curves for a bacterial anode made of carbon cloth plasma treated (CCP), stainless steel (SS) and a combination of CCP and SS (COMBP) to compare encapsulated anode material in a dialysis bag (D). These anodes designated D-CCP, D-SS and D-COMBP; the MECs were fed with Geobacter medium containing acetate as the carbon source. LSV measurements were performed on day 11. Scan rate was 5 mV s⁻¹ versus Ag/AgCl;

FIG. 16 presents LSV polarization curves of MEC with the encapsulated D50-COMBp anode (D50: dialysis bag with pore size of 50 kDa) utilizing acetate as the sole carbon source and wastewater. Potentials ranged from −0.5V to 0.8V vs. Ag/AgCl with scan rate of 5 mV s⁻¹;

FIG. 17 presents a graph of the viability of the bacterial anodes using MTT analysis: biofilm viability of the encapsulated D50-COMBp anodes in MEC fed with wastewater (A) or acetate (B); the non-encapsulated COMBp anodes in MEC fed with wastewater (C) or acetate (D). The results are normalized per 1 cm² anode. The P value between the encapsulated anodes (A+B) and the non-encapsulated anodes (C+D) P<0.05: and between the encapsulated anode in wastewater (A) and in acetate (B): P<0.08;

FIG. 18 presents the relative bacterial distribution with respect to genus: relative bacterial distribution in the biofilm of the encapsulated anode (D50-COMBp) in the MEC which was fed with acetate (A) and wastewater (B); the non-encapsulation anode (COMBp) in the MEC which was fed with wastewater (C); and the planktonic bacteria (D) in the MEC utilizing the COMBp anode;

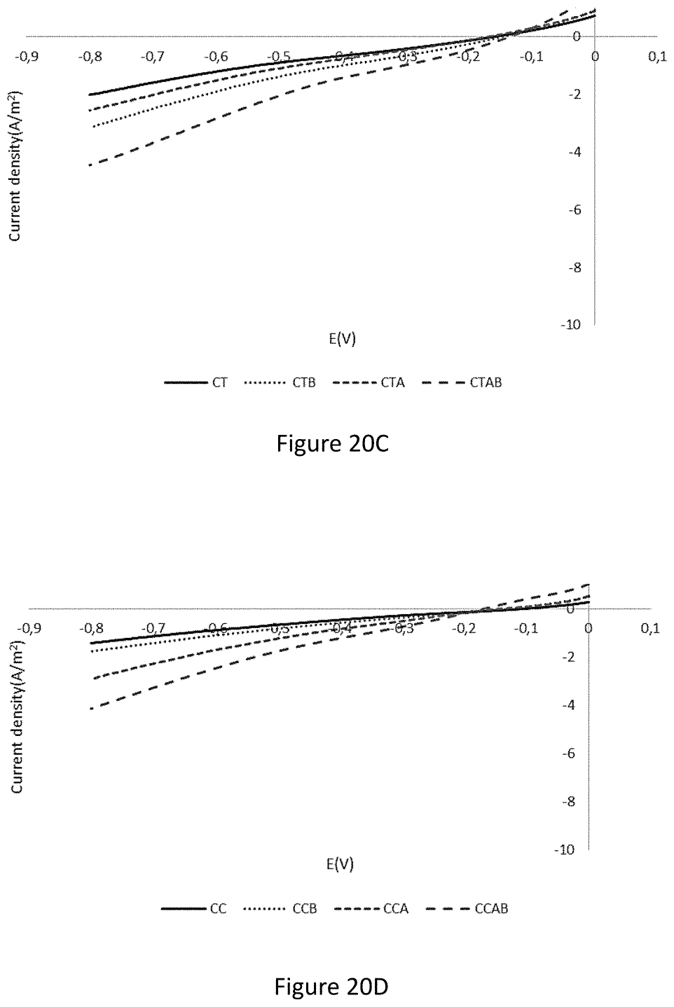

FIGS. 19A-19D present LSV-measurements for single chamber MECs based on the following bacterial anodes: carbon cloth with biofilm (CC), carbon cloth with biofilm encapsulated with nylon bag (CCB), carbon cloth with biofilm covered with alginate (CCA) and carbon cloth with biofilm covered with alginate and encapsulated with nylon bag (CCAB). The MECs were fed with acetate and WW. The LSV measurements were done on the 21th day when the MEC was fed with acetate (800 mg/L COD) (FIG. 19A), on the 30^{th} Day with acetate and wastewater with the ratio of 2:1 and (COD of 800 mg/L) (FIG. 19B), on the 36^{th} Day with acetate and wastewater with the ratio of 1:1 and (COD of 800 mg/L) (FIG. 19C), and on the 43^{rd} Day with wastewater as a substrate and (COD of 896 mg/L) (FIG. 19D);

FIGS. 20A-20D present LSV polarization curves for a cathode in a single-cell MEC based on the immobilized bacterial anodes (CCB, CCA, CCAB) and the non-immobilized anode (CC): on the 21th day when the MEC was fed with acetate (800 mg/L COD) (FIG. 20A), on the 30^{th} Day with acetate and wastewater with the ratio of 2:1 and (COD of 800 mg/L) (FIG. 20B), on the 36^{th} Day with acetate and wastewater with the ratio of 1:1 and (COD of 800 mg/L) (FIG. 20C), and on the 43^{rd} Day with wastewater as a substrate and (COD of 896 mg/L);

FIGS. 21A-21B present graphs of the relative bacterial distribution with respect to phylum (FIG. 21A) and genus (FIG. 21B). Relative bacterial distribution in the biofilm of the bacterial anodes in MEC which was fed with acetate and wastewater during the experimental period of 50 days and bacterial anodes were collected at the end of the experiment for bacterial distribution analysis;

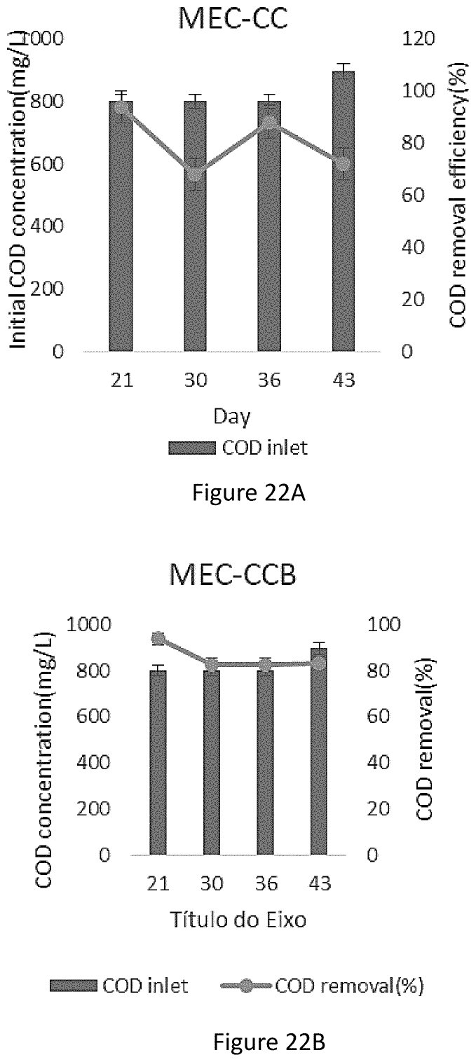

FIGS. 22A-22D present graphs of COD concentration (mg/L), COD removal (%) of CC (FIG. 22A), COD concentration (mg/L), COD removal (%) of CCB (FIG. 22B), COD concentration (mg/L), COD removal (%) of CCA (FIG. 22C) and COD concentration (mg/L), COD removal (%) of CCAB (FIG. 22D) at different concentration of substrates Day 21:Acetate; Day 30:Acetate and WW with 2:1 ratio; Day 36: Acetate and WW with 1:1 ratio; Day 43: raw WW;

FIGS. 23A-23B present LSV activity of MECs based on bacterial (Geobacter) anode where the FeMn catalyst doped on the carbon cloth. Abiotic anode with FeMn (CC-femn); bacterial anode with FeMn (CC-femn-B); bacterial anode without catalyst (CC-B). Oxidation currents (FIG. 23A) and reduction currents (FIG. 23B);

FIGS. 24A-24C present pictures of the FeMn catalyst doped plasma-treated carbon cloth before the experiment and anode biofilms after the experiment examined with a scanning electron microscope; and

FIG. 25 presents LSV measurements in MFCs based on the following anodes: kaolin (full line); Kaolin with graphite (dashed line); kaolin with activated carbon (dots line) and the control MEC where any material was added (line and dot).

### DETAILED DESCRIPTION OF THE INVENTION

According to some embodiments, the present invention provides an anode. In some embodiments, the anode is for use in microbial electrolysis cell (MEC).

In some embodiments, the anode comprises a bacteria and a conductive material. In some embodiments, the anode comprises bacteria, a polymer and a conductive material. In some embodiments, the anode comprises a catalyst. In some embodiments, the anode comprises a mineral. In some embodiments, the anode comprises a permeable mesh as an outer layer. In some embodiments, the immobilization of bacteria using a mesh prevents the invasion of non-desired bacteria into the anode. In some embodiments, the permeable mesh comprises a permeable plastic polymer.

According to some embodiments, the present invention provides a microbial electrochemical system comprising the anode described herein. In some embodiments, the anode comprises a permeable plastic polymer as an outer layer. In some embodiments, the permeable plastic polymer stabilizes the anode allowing for biofilm growth.

According to one aspect, there is provided an anode comprising bacteria, a polymer, and a conductive material, wherein the bacteria, the polymer and the conductive material are deposited on at least one surface of the anode.

According to another aspect, there is provided a method comprising: (a) providing the microbial electrochemical system disclosed herein; (b) contacting the microbial electrochemical system with a carbon source; and (c) providing an electrical current to the microbial electrochemical system.

### The Anode

According to some embodiments, the present invention provides an anode comprising bacteria, a polymer, and a conductive material, wherein the bacteria, and the polymer are deposited on at least one surface of the anode.

In some embodiments, the anode comprises a conductive material, a bacteria; and a polymer, a catalyst, a mineral, or any combination thereof, wherein the bacteria and the polymer, the catalyst, the mineral, or any combination thereof, are deposited on at least one surface of the anode.

In some embodiments, the anode comprises a conductive material, a bacteria, a polymer and a catalyst.

In some embodiments, the anode comprises a conductive material, a bacteria and a mineral.

In some embodiments, the anode comprises a conductive material, a bacteria, a polymer and a mineral.

The term “deposited” as used herein, refers to a material doped on a substrate, a material forming an outer layer on a substrate, or a material in contact with a substrate. In some embodiments, the bacteria is in the form of an outer layer on the anode. In some embodiments, the catalyst is doped on the anode. In some embodiments, the catalyst is doped on the conductive material. In some embodiments, the bacteria is in the form of an outer layer on the conductive material.

In some embodiments, the anode comprises a catalyst.

In some embodiments, the anode comprises 0.1 mg/cm² to 10 mg/cm², 0.5 mg/cm² to 10 mg/cm², 1 mg/cm² to 10 mg/cm², 5 mg/cm² to 10 mg/cm², 0.1 mg/cm² to 7 mg/cm², 0.5 mg/cm² to 7 mg/cm², 1 mg/cm² to 7 mg/cm², 5 mg/cm² to 7 mg/cm², 0.1 mg/cm² to 5 mg/cm², 0.5 mg/cm² to 5 mg/cm², or 1 mg/cm² to 5 mg/cm² of the catalyst, including any range therebetween.

In some embodiments, the catalyst comprises iron, manganese, vanadium, chromium, tungsten, tin, lead, bismuth, copper, nickel, silver, gold, titanium, platinum, palladium, iridium, ruthenium, molybdenum and their oxides, carbides, sulfides, selenides, phosphides, or any combination thereof. In some embodiments, the catalyst comprises iron and manganese.

In some embodiments, the bacteria is in the form of biofilm.

In some embodiments, the catalyst promotes charge transfer between the biofilm and the anode conductive material. In some embodiments, the catalyst promotes charge transfer between the biofilm and the anode structural materials. In some embodiments, the catalyst is doped on the anode conductive material. In some embodiments, the conductive material refers to the anode material.

In some embodiments, the polymer is used as a matrix hosting the bacterial cells. In some embodiments, the polymer immobilizes the bacteria to the anode. In some embodiments, the bacteria is in the form of biofilm. In some embodiments, the polymer is an organic polymer. In some embodiments, the polymer is an inorganic polysaccharide. In some embodiments, the immobilizing polymer comprises a plurality of polymers comprising organic compounds, inorganic compounds, or any combination thereof. As used herein, “plurality” is two or more. In some embodiments, the polymer comprises alginate, chitosan, agarose, kaolin, polyvinyl pyridine, poly ethers, poly vinyl alcohol and other hydrophilic polymers, or any combination thereof.

In some embodiments, the anode comprises 0.5 g to 5 g, 1 g to 5 g, 2 g to 5 g, 0.5 g to 4 g, 1 g to 4 g, 2 g to 4 g, 0.5 g to 3 g, 1 g to 3 g, or 2 g to 3 g, of the mineral including any range therebetween.

In some embodiments, the mineral comprises an opaque mineral. In some embodiments, the mineral comprises a clay mineral.

In some embodiments, the mineral comprises Kaolin, Smectite, Chlorite, Halloysite, Dickite, Montmorillonite Magnetite, Ilmenite, Hematite, or any combination thereof.

As used herein the term “clay mineral” refers to hydrous aluminium phyllosilicates. In some embodiments clay mineral comprise variable amounts of iron, magnesium, alkali metals, or alkaline earths.

In some embodiments, the anode comprises a mineral and a conductive material. In some embodiments, the anode comprises a mineral and a conductive additive.

In some embodiments, the conductive material comprises a redox polymer, carbon nanotube (CNT), graphene, activated carbon, carbon paper, carbon cloth, carbon felt, carbon wool, carbon foam, graphite, porous graphite, graphite powder, graphite granules, graphite fiber, electron conductive polymers (e.g., polythiophene, polyaniline), metal, metal complexes, metal-porpherine, metal-corolles, metal-selens, quinone, organic dye, redox active molecules, and any combination thereof.

In some embodiments, the conductive material refers to the anode material.

As used herein, “anode material” refers to the structural material the anode is made of. In some embodiments, the anode material comprises carbon paper, carbon cloth, carbon mesh, graphite plate, graphite rod, carbon foam and carbon brush. In some embodiments, the anode material comprises stainless steel.

In some embodiments, the anode material comprises carbon cloth. In some embodiments, the anode material comprises carbon cloth and stainless steel. In some embodiments, the carbon cloth is plasma treated.

In some embodiments, the anode comprises (i) plasma treated carbon cloth and stainless steel (ii) a bacteria, and (iii) a polymer.

In some embodiments, the anode comprises (i) plasma treated carbon cloth, (ii) a bacteria, and (iii) alginate.

In some embodiments, the anode comprises (i) plasma treated carbon cloth, (ii) a bacteria, (iii) kaolin and (iv) activated carbon, graphite particles, or both.

In some embodiments, the anode comprises (i) plasma treated carbon cloth, (ii) a bacteria, and (iii) a catalyst. In some embodiments, the anode comprises (i) plasma treated carbon cloth, (ii) a bacteria, and (iii) a catalyst, wherein the catalyst is doped on the plasma treated carbon cloth.

In some embodiments, the conductive material comprises the anode material and a conductive additive. In some embodiments, the conductive additive comprises a carbon particle, a metal particle or both. In some embodiments, the conductive additive comprises graphite particles. In some embodiments, the conductive additive comprises activated carbon. In some embodiments, the conductive additive increases electron transfer from the bacteria to the anode material.

In some embodiments, the ratio of the polymer and the conductive material ranges from 0.1:10 to 10:0.1, 0.1:9 to 9:0.1, 0.1:8 to 8:0.1, 0.1:7 to 7:0.1, 0.1:6 to 6:0.1, 0.1:5 to 5:0.1, 0.1:4 to 4:0.1, 0.1:3 to 3:0.1, 0.1:2 to 2:0.1, or 0.1:10 to 10:0.1. Each possibility represents a separate embodiment of the invention.

In some embodiments, the ratio of the polymer and the conductive material ranges from 0.1:1 to 1:0.1.

As used herein, “ratio” is a weight ratio (w/w), a mole ratio (mole/mole), or a concentration ratio (M/M, C/C).

In some embodiments, the bacteria are exoelectrogenic bacteria selected from Geobacteraceae, Shewanellaceae, Aeromonadaceae, Alteromonadaceae, Clostridiaceae, Comamonadaceae, Desulfuromonaceae, Enterobacteriaceae, Pasturellaceae, and Pseudomonadaceae.

As used herein, the terms “anodophiles” and “anodophilic bacteria” refer to bacteria that transfer electrons to an electrode, either directly or by endogenously produced mediators.

In some embodiments, the polymer comprises alginate and chitosan at a ratio of 0.1:1 to 1:0.1. In some embodiments, a ratio of 0.1:1 to 1:0.1 comprises: 0.1:0.9 to 1:0.1, 0.2:1 to 1:0.5, 0.3:0.8 to 0.85:0.2, 0.5:1 to 0.7:0.6, 0.1:0.5 to 1:0.6, 0.8:1 to 0.4:0.1, or 0.3:0.9 to 1:0.25. Each possibility represents a separate embodiment of the invention.

In some embodiments, the anode comprises a permeable mesh as an outer layer. In some embodiments, the anode comprises a permeable organic polymer, inorganic polymer or metal mesh as an outer layer. In some embodiments, the permeable mesh is selected from polyamide, cellulose, cellulose ester, polysulfone, polyethersulfone (PES), etched polycarbonate, and collagen. In some embodiments, the hole size of the mesh is smaller than 3 microns in diameter. In some embodiments, the permeable mesh is in the form of a bag. In some embodiments, the permeable mesh comprises Nylon. In some embodiments, the permeable mesh comprises a Nylon bag with a pore size in the range of 10 μm to 50 μm, 15 μm to 50 μm, 20 μm to 50 μm, 25 μm to 50 μm, 10 μm to 30 μm, 15 μm to 30 μm, 20 μm to 30 μm, 25 μm to 30 μm, 10 μm to 28 μm, 15 μm to 28 μm, 20 μm to 28 μm, 10 μm to 25 μm, 15 μm to 25 μm, or 20 μm to 25 μm, including any range therebetween.

In some embodiments, the permeable mesh comprises cellulose. In some embodiments, the permeable mesh comprises a cellulose a dialysis bag. In some embodiments, the dialysis bag has a pore size in the range of 1 kDa to 70 kDa, 2 kDa to 70 kDa, 10 kDa to 70 kDa, 15 kDa to 70 kDa, 20 kDa to 70 kDa, 1 kDa to 55 kDa, 2 kDa to 55 kDa, 10 kDa to 55 kDa, 15 kDa to 55 kDa, 20 kDa to 55 kDa, 1 kDa to 50 kDa, 2 kDa to 50 kDa, 10 kDa to 50 kDa, 15 kDa to 50 kDa, or 20 kDa to 50 kDa, including any range therebetween.

### The Electrochemical Cell

According to some embodiments, the present invention provides a microbial electrochemical system comprising the anode described herein. In some embodiments, the microbial electrochemical system comprises a semi-single-chamber, a single-chamber or a dual chamber. As used herein, “semi-single-chamber” refers to a microbial electrochemical system in which the anode comprises a permeable mesh as an outer layer. In some embodiments, semi-single-chamber refers to a microbial electrochemical system in which the anode is encapsulated in dialysis bag or nylon bag. This configuration protects the bacterial anode form invasion of undesired bacteria.

In some embodiments, the microbial electrochemical system comprises an anode enclosed in a permeable mesh comprising: a metal mesh, an organic polymer, an inorganic polymer, or any combination thereof. In some embodiments, the permeable mesh improves biofilm growth. In some embodiments, biofilm growth is improved by inoculating the bacterial cell suspension into the permeable mesh.

In some embodiments, the microbial electrochemical system comprises a cathode. In some embodiments, the cathode comprises a catalyst. In some embodiments, the catalyst forms a layer on at least one surface of the cathode. In some embodiments, the catalyst is a hydrogen reduction catalyst.

In some embodiments, the catalyst comprises nickel, iron, platinum, palladium, ruthenium, manganese, molybdenum oxides, carbides, sulfides, and any combination thereof. In some embodiments, the cathode is positioned opposite to the anode. In some embodiments, the cathode is positioned parallel to anode. In some embodiments, the distance between parallelly positioned cathode and anode is the length of any one of the cathode or anode, at most. In some embodiments the distance between the cathode and the anode ranges from 1 to 2 mm, 1 to 3 mm, 1 to 4 mm, 1 to 5 mm, 2 to 3 mm, 2 to 4 mm, 2 to 5 mm, 3 to 4 mm, 3 to 5 mm, or 4 to 5 mm. Each possibility represents a separate embodiment of the invention.

In some embodiments, a system as disclosed herein comprises a plurality of electrodes. In some embodiments the system comprises one cathode and at least 2 anodes, wherein at least 2 comprises at least 3, at least 4, at least 5, at least 7, at least 9, or at least 10 anodes, or any value and range therebetween. Each possibility represents a separate embodiment of the invention. In some embodiments the system comprises one anode and at least 2 cathodes, wherein at least 2 comprises at least 3, at least 4, at least 5, at least 7, at least 9, or at least 10 cathodes, or any value and range therebetween. Each possibility represents a separate embodiment of the invention.

In some embodiments, the herein disclosed system comprises an even number of anodes and cathodes, or an uneven number of anodes and cathodes. In some embodiments, the ratio of anodes to cathodes in the herein disclosed system is 1:1.

In some embodiments, the microbial electrochemical system is a microbial electrolysis cell (MEC). In some embodiments, the microbial electrochemical system is a microbial fuel cell (MFC). In some embodiments, the bacteria acts as a catalyst for generation of electrons and protons for production of electricity (in MFC) or hydrogen (in MEC).

In some embodiments, the microbial electrochemical system is for use in wastewater (WW) treatment, electricity generation, hydrogen production, or a combination thereof.

In some embodiments, the microbial electrochemical system is for use as an energy source. In one embodiment, the microbial electrochemical system is for use as an energy source such as for remote sensors.

In some embodiments, the microbial electrochemical system is for use in methane generation. Methane can be formed directly in MECs from the reduction of carbon dioxide combined with electrons and protons under the catalyzed effect of the planktonic anaerobic bacteria in the liquid and the electrochemically active bacteria (EAB) on the electrode surface.

In one embodiment, the microbial electrochemical system further comprises a reference electrode. In some embodiments, the microbial electrochemical system comprises an Ag/AgCl electrode.

In some embodiments, the microbial electrochemical system comprises conductive wires connected to the cathode, and to the anode. In some embodiments, the microbial electrochemical system comprises conductive wires connected to the cathode, to the anode and to the reference electrode. In some embodiments, the conductive wires are further connected to a potentiostat.

In some embodiments, a microbial electrochemical system comprising an anode as described herein comprising a permeable mesh as biofilm protection, comprises higher activity when compared to similar microbial electrochemical system with an anode without a permeable mesh. In some embodiments, a microbial electrochemical system comprising an anode as described herein comprising a permeable mesh as biofilm protection, comprises at least 1-fold, at least 5-fold, at least 10-fold, at least 20-fold, at least 50-fold, at least 70-fold, at least 100-fold, at least 200-fold, at least 500-fold or at least 1,000-fold higher activity when compared to similar electrochemical cell with an anode without a permeable mesh, or any value and range therebetween. Each possibility represents a separate embodiment of the invention.

In some embodiments, a microbial electrochemical system comprising an anode as described herein comprising a catalyst, comprises higher activity when compared to similar microbial electrochemical system with an anode without a catalyst. In some embodiments, a microbial electrochemical system comprising an anode as described herein comprising a catalyst, comprises at least 1-fold, at least 5-fold, at least 10-fold, at least 20-fold, at least 50-fold, at least 70-fold, at least 100-fold, at least 200-fold, at least 500-fold or at least 1,000-fold higher activity when compared to similar electrochemical cell with an anode without a catalyst, or any value and range therebetween. Each possibility represents a separate embodiment of the invention.

In some embodiments, a microbial electrochemical system comprising an anode as described herein comprising an immobilized bacteria as described herein, comprises higher activity when compared to similar microbial electrochemical system with an anode without immobilized bacteria. In some embodiments, a microbial electrochemical system comprising an anode as described herein comprising an immobilized bacteria as described herein, comprises at least 1-fold, at least 5-fold, at least 10-fold, at least 20-fold, at least 50-fold, at least 70-fold, at least 100-fold, at least 200-fold, at least 500-fold, or at least 1,000-fold higher activity when compared to similar electrochemical cell with an anode without immobilized bacteria, or any value and range therebetween. Each possibility represents a separate embodiment of the invention.

In some embodiments, the electrochemical cell is characterized by hydrogen evolution reaction (HER) rate in the range of 0.1 m³m⁻³d⁻¹ to 5 m³m⁻³d⁻¹. In some embodiments, the electrochemical cell is characterized by HER rate in the range of 0.1 m³m⁻³d⁻¹ to 5 m³m⁻³d⁻¹ comprises 0.2 m³m⁻³d⁻¹ to 5 m³m⁻³d⁻¹, 0.4 m³m⁻³d⁻¹ to 4.5 m³m⁻³d⁻¹, 0.7 m³m⁻³d⁻¹ to 3.5 m³m⁻³d⁻¹, 0.1 m³m⁻³d⁻¹ to 2.5 m³m⁻³d⁻¹, 0.15 m³m⁻³d⁻¹ to 1.1 m³m⁻³d⁻¹, 0.4 m³m⁻³d⁻¹ to 1.5 m³m⁻³d⁻¹, 0.3m³m⁻³d⁻¹ to 0.8 m³m⁻³d⁻¹, 0.1 m³m⁻³d⁻¹ to 0.75 m³m⁻³d⁻¹, or 0.35 m³m⁻³d⁻¹ to 0.95 m³m⁻³d⁻¹, including any range therebetween. Each possibility represents a separate embodiment of the invention.

In some embodiments, the electrochemical cell is characterized by chemical oxygen demand (COD) removal of 70% to 99%, 70% to 95%, 70% to 90%, 75% to 85%, or 70% to 80%, including any range therebetween. Each possibility represents a separate embodiment of the invention.

In some embodiments, the electrochemical cell is characterized by current density in the range of 2 A·m² to 30 A·m², 2 A·m² to 25 A·m², 2 A·m² to 20 A·m², 5 A·m⁻² to 30 A·m⁻², 5 A·m⁻² to 25 A·m⁻², or 5 A·m⁻² to 20 A·m⁻², including any range therebetween.

### The Method

In some embodiments, the present invention is directed to a method comprising: (a) providing the herein disclosed microbial electrochemical system; (b) contacting the microbial electrochemical system with a carbon source; and (c) providing an electrical current to the microbial electrochemical system.

In some embodiments, the present invention is directed to a method for treating wastewater, generating electricity, hydrogen production, or any combination thereof.

As used herein, “contacting” is by positioning the anode of the invention in the carbon source. In some embodiments, the anode is positioned, placed, incubated, or any equivalent thereof, in the carbon source. In some embodiments, contacting is flowing or moving the carbon source over the anode of the invention. In some embodiments, flowing or moving is continuously flowing or moving or periodically flowing or moving. In some embodiments, the carbon source is stationary.

As used herein, the term “carbon source” encompasses any substrate comprising molecules which can be utilized by an organism, such as a microorganism, as a source of carbon for biomass production. In some embodiments, the carbon source comprises an organic compound, an inorganic compound, or any combination thereof.

Types of a carbon source which can be utilized by microorganisms are common and would be apparent to one of ordinary skill in the art.

In some embodiments, the carbon source is a liquid carbon source.

In some embodiments, liquid carbon source comprises wastewater, acetic acid or acetate, citric acid or citrate.

In some embodiments, the carbon source comprises wastewater, acetate, or both. In some embodiments, the carbon source comprises acetate and wastewater at a ratio of 5:1 to 0.5:1, 5:1 to 0.5:1, 4:1 to 0.5:1, 3:1 to 0.5:1, 2:1 to 0.5:1, 1:1 to 0.5:1, 5:1 to 1:1, 5:1 to 1:1, 4:1 to 1:1, 3:1 to 1:1, or 2:1 to 1:1, including any range therebetween.

In some embodiments, the method is characterized by a COD of 600 mg/L to 1500 mg/L, 600 mg/L to 1200 mg/L, 600 mg/L to 1000 mg/L, 700 mg/L to 1500 mg/L, 700 mg/L to 1200 mg/L, 700 mg/L to 1000 mg/L, 800 mg/L to 1000 mg/L, 850 mg/L to 1000 mg/L, 900 mg/L to 1000 mg/L, or 800 mg/L to 1000 mg/L, including any range therebetween.

In some embodiments, the electrochemical cell is characterized by hydrogen evolution reaction (HER) rate in the range of 0.1 m³m⁻³d⁻¹ to 5 m³m⁻³d⁻¹. In some embodiments, the electrochemical cell is characterized by HER rate in the range of 0.1 m³m⁻³d⁻¹ to 5 m³m⁻³d⁻¹ comprises 0.2 m³m⁻³d⁻¹ to 5 m³m⁻³d⁻¹, 0.4 m³m⁻³d⁻¹ to 4.5 m³m⁻³d⁻¹, 0.7 m³m⁻³d⁻¹ to 3.5 m³m⁻³d⁻¹, 0.1 m³m⁻³d⁻¹ to 2.5 m³m⁻³d⁻¹, 0.15 m³m⁻³d⁻¹ to 1.1 m³m⁻³d⁻¹, 0.4 m³m⁻³d⁻¹ to 1.5 m³m⁻³d⁻¹, 0.3 m³m⁻³d⁻¹ to 0.8 m³m⁻³d⁻¹, 0.1 m³m⁻³d⁻¹ to 0.75 m³m⁻³d⁻¹, or 0.35 m³m⁻³d⁻¹ to 0.95 m³m⁻³d⁻¹, including any range therebetween. Each possibility represents a separate embodiment of the invention.

In some embodiments, the electrochemical cell is characterized by chemical oxygen demand (COD) removal of 70% to 99%, 70% to 95%, 70% to 90%, 75% to 85%, or 70% to 80%, including any range therebetween. Each possibility represents a separate embodiment of the invention.

In some embodiments, the electrochemical cell is characterized by current density in the range of 2 A·m² to 30 A·m², 2 A·m² to 25 A·m², 2 A·m² to 20 A·m², 5 A·m⁻² to 30 A·m⁻², 5 A·m⁻² to 25 A·m⁻², or 5 A·m⁻² to 20 A·m⁻², including any range therebetween.

In some embodiments, the method comprises providing the microbial electrochemical system with a current density ranging from −17 A·m⁻² to 55 A·m⁻².

As used herein, the term “current density” comprises electrical current.

### General

As used herein the term “about” refers to ±10%.

The terms “comprises”, “comprising”, “includes”, “including”, “having” and their conjugates mean “including but not limited to”.

The term “consisting of means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the term “method” refers to manners, means, techniques and procedures for accomplishing a given task including, but not limited to, those manners, means, techniques and procedures either known to, or readily developed from known manners, means, techniques and procedures by practitioners of the chemical, pharmacological, biological, biochemical and medical arts.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental support in the following examples.

### EXAMPLES

Reference is now made to the following examples, which together with the above descriptions illustrate some embodiments of the invention in a non-limiting fashion.

### Materials and Methods

### Treatment of Carbon Textile Using Cold Low-Pressure Nitrogen Plasma

The carbon-textile anode material was treated with cold low-pressure nitrogen plasma, using a plasma cleaner system (Harrick PDC-32G-2, USA, RF of 60 Hz, power of 18 W) for 2 minutes at a pressure of 2 torrs. Nitrogen cylinders (>99.00%) were purchased from Oxygen and Argon Works Ltd., Israel. The treated anodes were rinsed in demineralized water to preserve the hydrophilic nature of their surface. The plasma-treated electrodes were used for the immobilization of G. sulfurreducens with alginate and chitosan, with alginate alone, and as a non-immobilized anode.

G. sulfurreducens Immobilization on Anodes Using Alginate, and Alginate-Chitosan

The first stage of preparing the anodes was to increase their wettability by exposing them to cold low-pressure nitrogen plasma. Then the process for bacterial immobilization on the anode was carried out using carbon textile with alginate, or with alginate and chitosan. In preparing plasma-treated carbon textile with immobilized bacteria using alginate (A-bacterial anode), 3% (w/v) sodium alginate was dissolved in 10 mL boiled distilled water (alginate solution) and gently shaken (24° C., 1 min) with 10 mL G. sulfurreducens (1.0 OD₅₉₀). This was followed by immersing the anodes into the bacteria-alginate suspension; 1.09±0.1 mL of the suspension was attached to each of the anodes. The immersed anodes (containing the alginate and bacteria) were transferred to 150 mL of BaCl₂ solution, incubated for 1 h for alginate polymerization (A-1 bacterial anode), and sparged with N₂ gas to maintain an anaerobic environment. After soaking in the BaCl₂ solution, the electrodes were rinsed with sterile water and kept in Geobacter medium until set into the MEC.

In preparing plasma-treated carbon textile with immobilized bacteria using alginate and chitosan (AC-bacterial anode), 3% (w/v) sodium alginate was dissolved in 10 mL boiled distilled water (alginate solution) and gently shaken (24° C., 1 min) with 10 mL G. sulfurreducens (1.0 or 0.1 OD₅₉₀) (AC-1 and AC-0.1 bacterial anodes, respectively). The immersed anodes (containing the alginate and bacteria) were transferred to 150 mL of BaCl₂ solution and incubated for 1 h for alginate polymerization. The alginate-immobilized anodes were submerged into a 0.25% chitosan solution (0.25% chitosan in 1% acetic acid, the pH was increased to 6.0 by adding 0.1 M NaOH) and kept under mild shaking for 10 minutes; each anode absorbed 0.31±0.05 mL chitosan. The electrodes were rinsed with sterile Geobacter medium and kept in Geobacter medium until set into the MEC.

### Operation of MEC Utilizing the Immobilized and Non-Immobilized Anodes

A single-chamber MEC was constructed using commercially available glass bottles (ISO LAB, Germany) with a total volume of 100 ml and a working volume of 80 ml. The bottles were sealed with a screw cap and GL-45 silicone rubber septa stoppers (SCHOTT AG, Germany) to avoid air exposure. Woven carbon textile (Fiber fabric parex 30-Fuel Cell Store, USA) (2.5 cm×2.5 cm) was used for immobilized and non-immobilized anodes. For the cathode, one side of a carbon cloth (2.5 cm×2.5 cm) was platinum (Pt-0.5 mg cm⁻²) coated (Fuel Cell Store, USA). The electrodes were spaced parallel to each other and separated by a polypropylene spacer net. Titanium wires were used as conductive material for both working and counter electrodes. An Ag/AgCl electrode (3.0 M KCl) (+199 mV vs SHE) (ALS Co., Ltd, Japan) was used as a reference electrode. Prior to constructing the MEC, each working electrode (carbon textile) was pretreated by cold low-pressure nitrogen plasma.

The different anodes were tested in quadruplicate: the carbon-textile anode that was only plasma-treated (non-immobilized anode), the plasma-treated carbon cloth with immobilized G. sulfurreducens using alginate with a turbidity of 1 OD₅₉₀ (A-1 bacterial anode), and the plasma-treated carbon cloth with immobilized G. sulfurreducens using alginate and chitosan, with a turbidity of 1.0 or 0.1 OD₅₉₀ (AC-1 or AC-0.1 bacterial anode, respectively). The MEC that was based on the non-immobilized anode was inoculated with approximately the same bacterial amount as were the immobilized anodes. The MECs were replenished with Geobacter medium containing sodium acetate (10 mM) or with wastewater (WW) (1,000 to 1,600 mgL⁻¹ COD) and maintained at a temperature of 35° C. The cells were placed on a magnetic stirrer for continuous electrolyte stirring at 120 rpm. The duration of the experiment was 5 weeks to provide enough time for bacterial development and investigation of bio-electrochemical activities.

G. sulfurreducens Inoculum

G. sulfurreducens (DSMZ 12127) was grown in Geobacter medium (N′ 826, DSMZ Germany) in 12 borosilicate glass serum bottles in an 80% N₂: 20% CO₂ atmosphere for about 5-6 days until a significate of red bacterial aggregates was formed.

Inoculum of G. sulfurreducens

A pure culture of G. sulfurreducens (DSMZ 12127) was grown in Geobacter medium (N′ 826, DSMZ Germany), under a 80% N2: 20% CO₂ atmosphere, in a 50 ml borosilicate glass serum bottle with a 20 mm butyl septum (Wheaton Glass Co, USA) for about 10 days, until red bacterial aggregates settled on the bottom of the bottle. The supernatant was eluted, and a highly concentrated bacterial suspension was agitated for several minutes. The optical density (OD) was measured using a GENESYS 10S UV-Visible spectrophotometer (Thermo Scientific, USA) at 590 nm. Each of the MECs was inoculated with 10 ml of G. sulfurreducens 0.35 OD±0.05. In the MECs based on the encapsulated anode, the inoculation was performed directly into the dialysis bag.

### Anode and Cathode Materials

The anode materials were carbon cloth (CC) (E-TEK W1400 LT, USA) that was plasma-pretreated to increase anode surface hydrophilicity (CCp), stainless steel (SS) (316L, 80 mesh, INOXIA, UK), and a combination of SS and CCp (COMBp). Each electrode size was 2×2 cm (4 cm²). The cathodes were comprised of carbon cloth coated with 0.5 mg cm⁻² Pt/60% on carbon support (CTM-GDE-02, FuelCellsEtc, USA), with a geometric area of 4 cm² (2×2 cm).

### MEC Setup

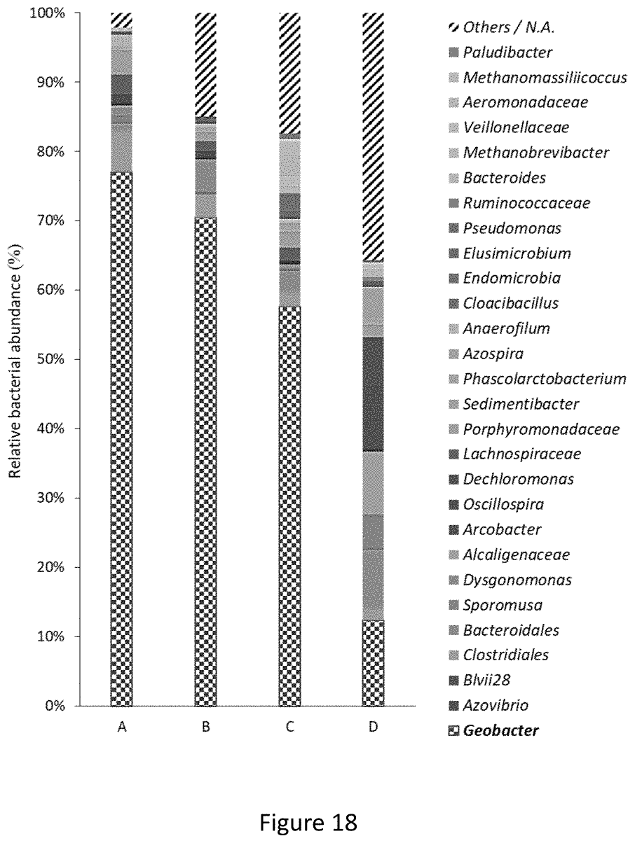

The semi-single-chamber MEC (500 mL borosilicate bottle with GL45 open cap (see FIG. 14) included a double-layer silicone/PTFE septum, which was filled with 400 mL of 90% Geobacter medium (N′ 826, DSMZ Germany) and 10% 1 M phosphate buffer (final concentration of 100 mM, pH 6.8). The MECs contained the following electrodes: a cathode, an Ag/AgCl 3M KCl reference electrode (RE-1CP, ALS, Japan), and an encapsulated or non-encapsulated anode. In the MECs using the encapsulated anode, the G. sulfurreducens (10 mL 0.35OD±0.05) was injected through the upper side of the dialysis bag, making a small pinhole in its top. The control MECs were inoculated via injection into the whole volume of the MEC system. The MECs (4 replicates of each MEC with its encapsulated or non-encapsulated anode) were placed in a thermostatic bath at 35° C. and operated under a constant potential of 0.3V (versus an Ag/AgCl reference electrode) using a potentiostat (Ivium N-Stat, Netherlands) for 30 days.

### Dialysis Bags Enclosing Improvement of SS, CCP and COMBP Bioanodes to Form D-SS, D-CCP, and D-COMBP Bioanodes

Dialysis tubing cellulose membrane with molecular weight of 2 kDa (132108, SPECTRUM, The Netherlands), 14 kDa (D9527, Sigma-Aldrich Co., USA) and 50 kDa (132130, SPECTRUM, The Netherlands) were used as anode and inoculum storage for biofilm growth enclosing improvement. The 10 cm pieces of dialysis tubes boil at 2% sodium bicarbonate/1 mM EDTA solution for 10 min. After boiling, rinse tubing thoroughly with ddH2O, boil tubing thoroughly in ddH2O for 10 min and storage at 50% Ethanol/1 mM EDTA to avoid contaminations.

Dialysis tube pieces were closed on one side by knot avoid liquid leaks to bag formation. 10 mL of 90% Geobacter medium (N′ 826, DSMZ, Germany) and 10% 1 M PB final concentration of 100 mM, pH 6.8 was sparged with 80% N2-20% CO₂ gas mixture and added at glove box with nitrogen atmosphere (BACTRON, Shel Lab, USA) to each dialysis tube-bag. SS, CCP, COMBP electrodes was inserted to dialysis tube-bag to form D-SS, D-CCP and D-COMBP, separately. After electrode insertion to bags, each bag was sealed at top, around electrode wire, to form dialysis bag with electrode to form enclosing bioanodes. Dialysis bags include electrodes was transported to MEC chamber, the MEC was sparged again to avoid any oxygen contaminants. Bacterial strain of Geobacter sulfurreducens (DSMZ 12127) was added, under anoxic conditions, by septum with 120 mm 21G sterile needle (B. BRAUN Melsungen A G, Malaysia) into top headspace of dialysis bags to get a final concentration of 0.35 OD±0.05.

### Scanning Electron Microscopy (SEM) Analysis of the Bacterial Anodes

The AC-1 and A-1 bacterial anodes and the non-immobilized anode were collected from the MECs at the end of the experiment and were washed 3 times with a phosphate buffer solution. The samples were fixed by incubation in Karnovsky's fixative solution (mixture of 5% glutaraldehyde and 4% formaldehyde in 0.064 M phosphate buffer, pH 7.2) followed by incubating for 1 h in tannic acid (1%) and OsO₄ (4%) to prevent bacterial cell shrinkage and thermal damage. The samples were washed three times with the phosphate buffer solution (pH 7.2) between each process. Finally, they were dehydrated using ethanol (30-100%) for 15 min each concentration. The samples were air-dried and sputtered with gold. The morphology of the anodes was examined using a MAIA3 in ultra-high-resolution SEM (TESCAN, Czech Republic).

### Microbial Community Analysis

The microbial community analysis was conducted by HyLabs Pvt Ltd, Israel. DNA was extracted using the DNeasy Powersoil kit (Qiagen) according to the manufacturer's instructions. A 16S-rRNA library preparation for sequencing on Illumina was performed using a 2-step PCR protocol. In the first PCR, the v4 region of the 16S-rRNA gene was amplified using the 16s 515F and 806R from the Earth Microbiome Project with CS1 and CS2 tails. The second PCR was done using the Fluidigm Access Array primers for Illumina, to add the adaptor and index sequences. Sequencing was done on the Illumina MiSeq, using a v2-500 cycles kit to generate 2×250 paired-end readings. Demultiplexing was performed on Basespace (the Illumina cloud), to generate FASTQ files for each sample. The data was furthered analyzed using CLC-bio to generate OTU and Abundance tables.

### Electrochemical Analysis

The MEC was connected to a MultiEmStat3+ potentiostat (Palmsens, Netherlands) in a 3-electrode configuration. Potentiostatic control was maintained by poising the anode to +0.3V vs. Ag/AgCl (3.0 M KCl). Linear sweep voltammetry (LSV) was performed in the potential range of −0.5 to 0.8V and scan rate of 5 mV s⁻¹, in order to acquire mechanistic and phenomenological data of the processes occurring in the system. In all the cases potential (V) against Ag/AgCl reference electrode until further mentioned. A differential pulse voltammetry (DPV) was applied in the same potential range for determining the current-voltage (I-V) curve under semi-steady-state stable conditions. Chemical oxygen demand (COD) and pH were determined using APHA standard methodologies. COD was determined using a closed reflux COD digester, (MRC Labs, China), while pH was determined with a pH meter. Electrochemical tests were performed using a MultiEmStat3+ potentiostat (Palmsens). The chemicals and reagents used were of analytical grade, and distilled water was used for medium preparation. ANOVA testing was performed in Microsoft Excel for all the comparisons.

Hydrogen production rate was measured in the 2-electrode configuration, under an applied constant potential in the range of 0.2 to 0.8V. The hydrogen production rate was calculated according to Equations 1 and 2, herein below.
(1) Q_{H}_{₂}=V_{H2}[m³]×t[d⁻¹]×Vᵣ[m⁻³], wherein VH₂=Volume of hydrogen production (m³); t=time (seconds/day); Vr=Volume of reactor (m³).

$${V}_{{H}_{2}} = \frac{I \times t \times R \times T}{k \times F \times P} , \qquad ( 2 )$$

wherein, I=Current (A); t=Time (s); R=Gas constant (0.0820577 L atm (mol⁻¹·K⁻¹); T=Gas temperature (K); k=Valence of substrate; F=Faraday's constant (96,485 C·mol⁻¹); P=Gas pressure (atm).

### Linear Sweep Voltammetry (LSV) Measurements

LSV measurement of oxidation currents was performed in a MEC using a potentiostat by a three-electrode configuration type, with a carbon cloth coated by Pt as a counter electrode, Ag/AgCl as a reference electrode and the working electrode was the examined bio-anodes. The applied potential range was −0.5V to 0.8V, versus Ag/AgCl increase in a scan rate of 5 mV·s⁻¹. LSV measurement of reduction currents was performed in a MEC using a potentiostat by a two-electrode configuration type, with a carbon cloth coated by Pt connected together with Ag/AgCl reference electrode, both, as a working electrode and the counter electrode was the examined bio-anodes. The applied potential range was 0V to 1V, in a scan rate of 5 mV·s⁻¹.

Biofilm Viability on the Bioanodes after MEC Operation for 30 Days (MTT)

Examination of the biofilm viability on dialysis enclosed D2-COMBP, D14-COMBP, D50-COMBP and non-dialysis COMBP bioanodes, under acetate and wastewater (WW) were performed at the end of MEC operation in anoxic conditions, using MTT analysis (3-(4,5-dimethylthiazol-2-yl)-2,5-diphenyltetrazolium bromide, Merck, Germany). Each anode (4 cm²) with the attached biofilm was washed three times with PBS to remove the planktonic bacteria. The anode was transferred to 50 mL tubes containing 15 mL of MTT solution and was incubated for 2 h at room temperature in the dark. Then the MTT solution was removed and replaced by 15 mL of dimethyl sulfoxide:EtOH solution (1:1 ratio) for 20 min. The absorbance of the solution was examined using a spectrophotometer at OD₅₄₀. The absorbance results corresponded to a 1 cm² electrode area.

### Chemical Oxygen Demand (COD) Removal and Coulombic Efficiency (CE)

The chemical oxygen demand (COD) (in g/L) represents the amount of oxygen that would be needed to fully oxidize the carbon sources compounds. Oxygen reduction requires two electrons per oxygen atom (4 per O₂); which should be taken into consideration when calculating the electric charge required for an electrochemical oxidation of the carbon sources.

COD were determined using APHA standard methodologies (APHA-AWWA-WPCF, 1998), using closed reflux COD digester, (mrc labs, China), while pH was determined with a pH meter (Gundu et al. 2019).

The Coulombic efficiency (CE) (in %) is defined as the ratio of total Coulombs actually transferred to the anode from the substrate, to maximum possible Coulombs if all substrate removal produced current. The total Coulombs obtained is determined by integrating the current over time, so that the Coulombic efficiency for an MFC or MEC run in fed-batch mode, evaluated over a period of time tb, is calculated as (Cheng, et al., 2007, 40, 18871-18873, Logan B. et al., VOL. 40, NO. 17, 2006)

$${ϵ}_{Cb} = \frac{M {\int }_{0}^{tb} Idt =}{FbvAn Δ COD} , \qquad ( 3 )$$

wherein M=32 gr·mol⁻¹ is the molecular weight of oxygen, F=96485 C·mol⁻¹-electrons is Faraday's constant, b=4 is the number of electrons exchanged per mole of oxygen, v_{An}=is the volume of liquid in the anode compartment, and ΔCOD is the change in COD over time tb (Logan B. et al., VOL. 40, NO. 17, 2006)

### Microbial Analysis of Biofilm and Planktonic Community

Examination of the microbial community on dialysis enclosed 50-COMBP and non-dialysis COMBP bioanodes biofilm and planktonic, under acetate and wastewater (WW) ware performed at the end of MEC operation was done by Next-generation sequencing (NGS) analysis (HyLabs Pvt Ltd, Israel). DNA was extracted using the DNeasy Powersoil kit (Qiagen) according to the manufacturer's instructions. 16S-rRNA library preparation for sequencing on Illumina was performed using a 2-step PCR protocol. In the first PCR, the v4 region of the 16S-rRNA gene was amplified using the 16s 515F and 806R from the earth microbiome project with CS1 and CS2 tails. The second PCR was done using the Fluidigm access array primers for Illumina- to add the adaptor and index sequences. Sequencing was done on the Illumina MiSeq using a v2-500 cycles kit to generate 2×250 paired-end reads. Demultiplexing was performed on Basespace (the Illumina cloud), to generate FASTQ files for each sample. The data was furthered analyzed using CLC-bio to generate OTU and Abundance tables.

### Statistics

Data are expressed as means±STDEV (standard deviation) of between 4-6 replicates. The results were statistically analyzed using one-way analysis of variance (ANOVA). Differences between the values were considered significant at P-value<0.05.

### Example 1

Electrochemical Activity of MEC Based on AC Anodes Inoculated with Different Bacterial Concentrations

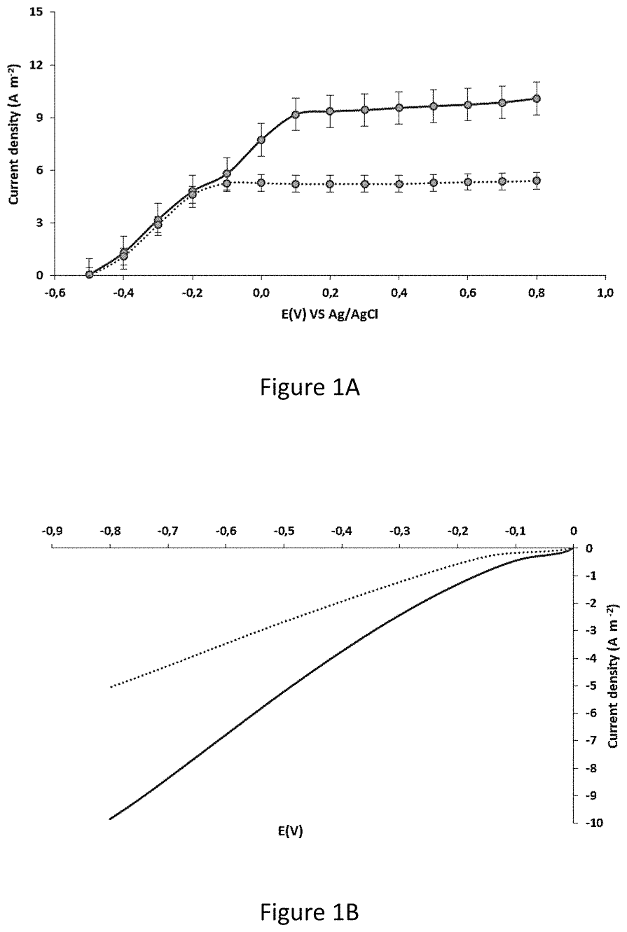

To determine the optimal cell inoculation in the immobilized bacterial anode, an alginate bacterial solution was prepared containing 3% sodium alginate: G. sulfurreducens culture (0.1 or 1.0 OD₅₉₀ nm) in a ratio of 1:1. The carbon-textile anode was immersed in the alginate bacterial solution, at which time about 1 ml of the solution was attached to the anode. The anode was transferred to a BaCl₂ solution for alginate polymerization, then submerging it in a chitosan solution to strengthen the ionic interactions. In this step, about 0.3 ml of the chitosan solution was attached to the alginate anode. The alginate-chitosan (AC) bacterial anode was connected to the MEC; and on the 30^{th} day, DPV measurement was conducted using acetate as the carbon source for the AC bacterial anode activity. As shown in FIG. 1A, the MEC based on the AC bacterial anode with inoculation of 1 OD (the AC-1 bacterial anode) produced a current density of 10.09±0.03 A·m⁻². In contrast, the MEC with the lower bacterial density of 0.1 OD (the AC-0.1 bacterial anode) generated only 5.40±0.15 A·m⁻². It is interesting to note that in both cases, the onset potential, defined by the rise of the oxidation current above the background level, was nearly −0.5V. A plateau curve was obtained from 0.1V and −0.2V vs. Ag/AgCl, for the AC-1 bacterial anode and the AC-0.1 bacterial anode, respectively. The plateau curve was continued up to the highest potential used in this study, 0.8V. A higher potential is within the possible range of electrolyte oxidation.

Similar results were reported by Guo et al. (2017) using a stainless-steel flame-oxidized electrode, where the onset current was around −0.45V vs. Ag/AgCl, and a plateau curve was observed from −0.2V until 0.2V. Flexer et al. (2016) studied a prospective new microbial hierarchical porous electrode. The results showed that the onset potential was −0.45V and reached a plateau of maximum current at around 0.15V vs Ag/AgCl. They suggested that the maximum current was limited by either the enzymatic activity of acetate degradation, or the diffusional limited current of reactive intermediates through the three-dimensional film on the electrode; i.e., the arrival of acetate and diffusion of 1-1±outside of the biofilm.

The effect of bacterial concentration in the immobilized layer on hydrogen formation was examined using an MEC utilizing the AC-1 and AC-0.1 bacterial anodes. These MECs were connected to the potentiostat in a 2-electrode configuration (the working electrode was connected to the platinized carbon cloth, while the reference and counter electrodes were connected to the AC-1 bacterial anode or the AC-0.1 bacterial anode). As can be seen in FIG. 1B, the MEC employing the AC-1 bacterial anode yielded the highest cell current density, 9.75±0.053 A·m⁻² at an applied voltage of 0.8V; while the MEC operating with the AC-0.1 bacterial anode produced only 5.04±0.15 A·m⁻². A 52% higher hydrogen evolution rate (at a potential of 0.8V) was calculated with the AC-1 bacterial anode (1.47 m³m⁻³ d⁻¹), compared to the AC-0.1 bacterial anode (0.76 m³m⁻³ d⁻¹). 5 mV s-¹). MEC: based on the AC-1 and AC-0.1 bacterial anode in a single-cell MEC.

### Example 2

DPV Measurements of MECs Utilizing Immobilized and Non-Immobilized Anodes, where the Carbon Source is Acetate or Wastewater

Current and hydrogen production in MECs based on the AC-1 bacterial anode were compared to the anode which was immobilized using only alginate with the same bacterial inoculum. In this case, the carbon-textile anode was immersed only in an alginate bacterial solution containing a suspension of sodium alginate: G. sulfurreducens culture (1 OD₅₉₀ nm) in a ratio of 1:1, followed by transferring to BaCl₂ for alginate polymerization. This anode was designated as the A-1 bacterial anode. Another MEC control was constructed using the same bacterial inoculation as for AC-1 and A-1 bacterial anodes, but without the immobilization process. This control was designated as the non-immobilized bacterial anode, and the inoculum was added directly to the MEC medium.

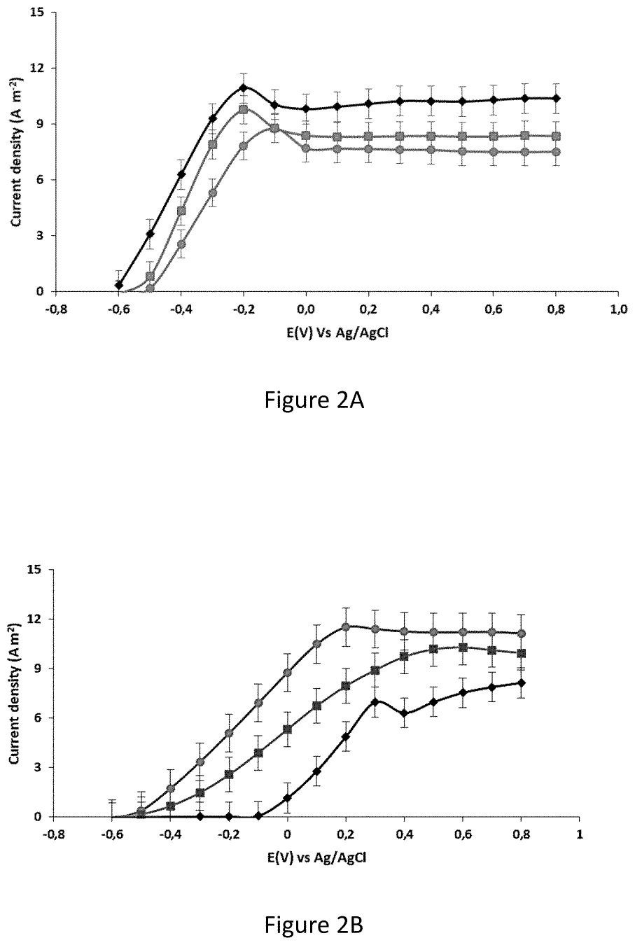

DPV was measured in a set of 15 potentials (between −0.6-0.8V vs. Ag/AgCl), with time intervals of 300 sec at each potential; it was conducted on the 20^{th} day with acetate, and on the 29^{th} day in WW (FIGS. 2A-2B).

FIG. 2A shows the measured current density attained upon electrode potential polarization, in the range of −0.6 to 0.8V (vs. Ag/AgCl) in the MEC operated on acetate. The highest current density values were obtained at the applied-potential range of −0.2 to −0.1V. The current densities of the immobilized anodes were 9.77±0.271 A·m⁻² and 8.78±0.096 A·m⁻², for A-1 and AC-1, respectively. The non-immobilized anode led to the highest current density of 10.95±0.714 A·m⁻², 15%, which exceeds that of the immobilized anodes. A plateau curve of all measured anodes occurred up to the highest measured potential, 0.8V. FIG. 2B shows the measured current densities when WW was used as the carbon source. The MEC applying the AC-1 bacterial anode led to the highest current density value of 11.52±0.0924 A·m⁻² at a potential of 0.2V. In the A-1 bacterial anode, the maximum current density was 10.30±0.347 A·m⁻² under the applied voltage of 0.5V. In contrast, the non-immobilized anode showed a maximum current density of only 8.14±0.025 A·m⁻² at the applied potential of 0.8V. In the MEC which was operated using WW, the plateau region of these curves began at 0.2, 0.5 and 0.3V, for AC-1, A-1 and non-immobilized anodes, respectively. When the MEC was fed with acetate, the plateau curves were begun at lower applied potentials of about −0.1 to 0V.

### Example 3

Hydrogen Formation in the MECs Based on the Immobilized Bacterial Anodes (AC-1 and A-1) and the Non-Immobilized Anode

The effect of the immobilized bacterial anodes (AC-1 and A-1) and the non-immobilized anode on the rate of hydrogen formation was examined when the different MECs were in a complete cell (2-electrode configuration).

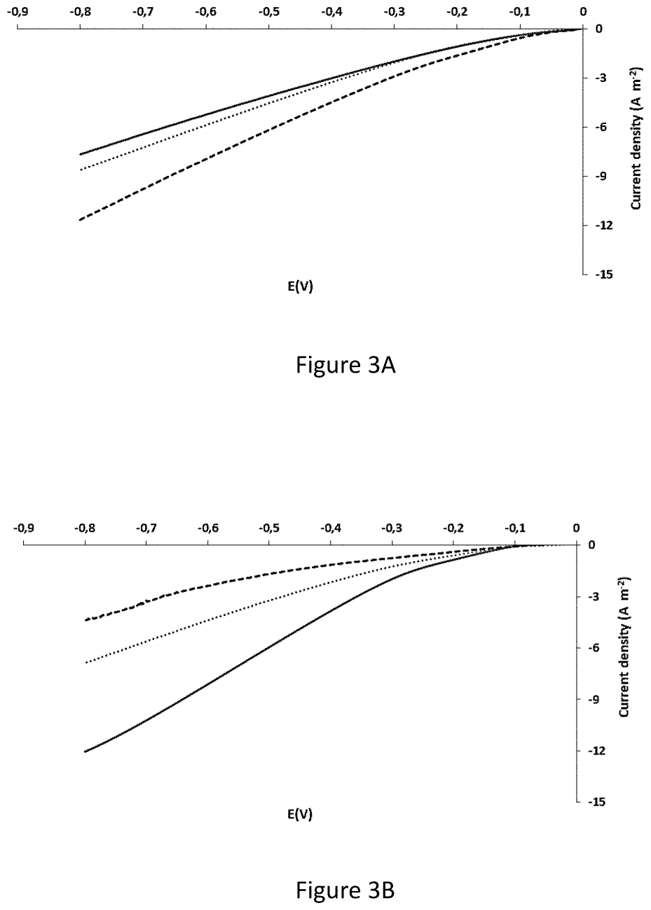

The LSV steady-state polarization for a cathode in the MECs was examined when the MEC was operated in acetate (FIG. 3A) and in WW (FIG. 3B). The results depicted in FIG. 3A show that the highest hydrogen reduction current (11.52±0.643 A·m⁻² at applied cell voltage of 0.8V) was obtained in the MEC with the non-immobilized anode fed by acetate. While in WW, the MEC applying the AC-1 bacterial anode led to the highest reduction current (12.01±0.391 A·m² at applied cell voltage of 0.8V; FIG. 3B).

Calculation of hydrogen evolution rates was performed according to the aforementioned equations (1) and (2) in the “Materials and Methods” section. Under the applied voltage of 0.5V and in acetate, the current densities obtained in the MECs based on the AC-1, A-1 and non-immobilized anodes were 4.10, 4.57 and 6.17 A·m⁻² and 5.96, 3.22 and 1.66 A·m⁻² in WW, respectively. In applying these MECs (AC-1, A-1 and non-immobilized anodes), the hydrogen evolution rates per cubic meter of the anodic medium, under the applied voltage of 0.5V with acetate as the carbon source, were 0.39, 0.43, 0.58 m³·m⁻³·d⁻¹; and with WW, 0.56, 0.30, 0.16 m³·m⁻³·d⁻¹, respectively.

To summarize, when WW was used as the carbon source, the hydrogen production in the MEC utilizing the AC-1 bacterial anode was the highest (3.5-fold higher compared to the non-immobilized anode). Meanwhile, in acetate the non-immobilized anode led to the highest hydrogen production (but only 1.4-fold higher compared to the AC-1 bacterial anode).

### Example 4

Measuring the Currents Versus Time in MECs Based on the AC-1 Bacterial Anode Using Acetate and Wastewater as the Carbon Source for the Bacterial Anode Activity

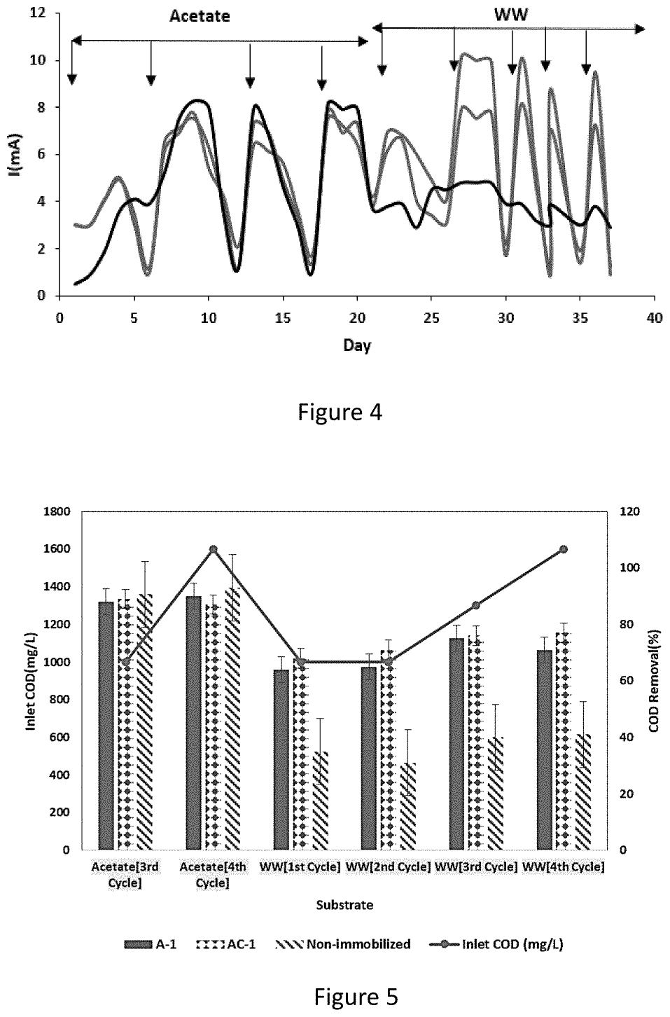

The currents obtained in MECs based on the AC-1, A-1 and non-immobilized bacterial anodes were measured during 37 days under an applied voltage of 0.3V. The MECs were operated with acetate during 1 to 21 days, and with WW as the carbon source from 22 to 37 days (FIG. 4). On the 9^{th}-10^{th} day, all the MECs reached a peak current of about 7.83 mA, and in each MEC the current decreased after several days with the depletion of acetate. Upon adding acetate, an increase in the produced current was seen, and in the 4^{th} cycle of acetate feeding (18^{th} day), the observed currents were similar in all the MECs: around 7.1 to 8.1 mA. A slightly higher current was observed in the MEC utilizing the non-immobilized anode (8.14 mA), compared to the immobilized anodes (7.5 and 7.8 mA). On the 21s^{t} day, the average observed current in the three MECs was about 3.9 mA. On the 22^{nd} day, the MECs were fed with WW (1,000 mg·L⁻¹ COD), and the current in the MEC utilizing the non-immobilized bacterial anode was only 3.81 mA. In comparison, the MECs utilizing the immobilized anodes exhibited currents of 6.13 (A-1) and 6.91 (AC-1) mA, respectively. On the last 3 cycles of WW feeding, the current produced by the AC-1 bacterial anode was between 8 and 10 mA, and about 8 mA with the A-1 bacterial anode. In contrast, the non-immobilized bacterial anode yielded only 3 to 4 mA. The inventors hypothesized that the higher activity of the MEC utilizing the AC-1 bacterial anode is attributed to the protection of the anode biofilm from invasion by non-exoelectrogenic bacteria present in the WW.

### Example 5

COD Removal

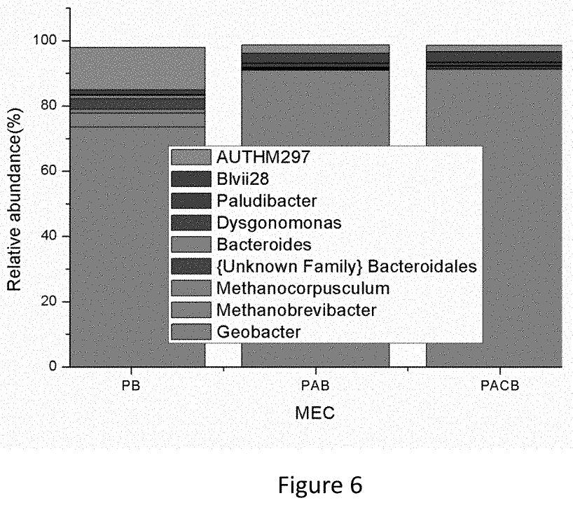

Acetate and WW organic material degradation rates were evaluated by analyzing the COD in MECs applying the immobilized and the non-immobilized anodes. The COD inlet (in a range of 1,000-1,600 mg·L⁻¹) and removal percentages, where the carbon source for the MECs was acetate or WW, are shown in FIG. 5. The 3^{rd} and 4^{th} cycles of adding acetate (the only acetate cycles shown in FIG. 5) revealed about 95% COD removal in all MECs. A slightly higher COD removal was observed in the MEC based on the non-immobilized anode (90%), compared to the immobilized anode (85%). In the first two cycles of adding WW with a COD of 1,000 mg·L⁻¹, the COD removal percentage was about 75% in MECs based on the immobilized anode, whereas in the MEC based on the non-immobilized anode it was only 40%. In the 3^{rd} and 4^{th} cycles of adding WW with the inlet COD of 1,000 and 1,600 mg L⁻¹, respectively, the COD removal percentage was about 78% in the MEC based on the immobilized anode; in the non-immobilized anode it was only 40%.

### Example 6

Microbial Diversity Analysis on the Immobilized and Non-Immobilized Bacterial Anodes

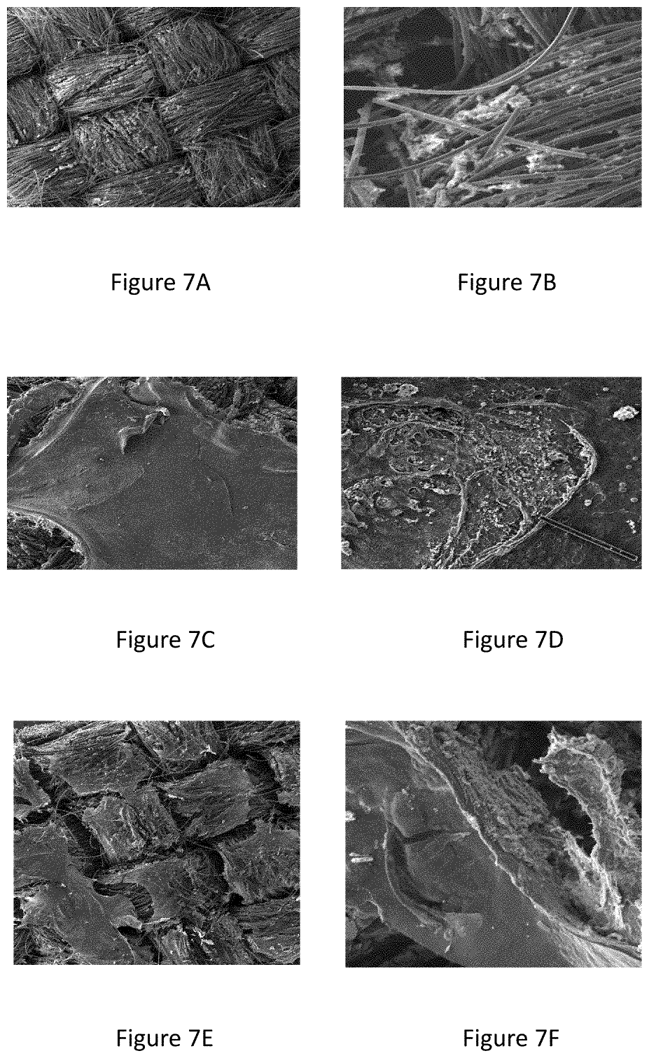

The microbial diversity in the biofilm of the immobilized anodes was compared to the non-immobilized anode after the MECs were operated for four weeks in WW. The microbial diversity of each anodic biofilm was evaluated, based on 16S-rRNA. Operational taxonomic unit (OTU) readings were identified and phylogenetically classified. A total of 9 distinct phyla and nearly 30 genera were identified (Table 2 and FIG. 6) in all bacterial anodes. The microbial community varied significantly in the immobilized and non-immobilized MECs. In the three bacterial anodes, the dominant phylum was Proteobacteria. The non-immobilized anode biofilm included 74.33% Proteobacteria, while the A-1 and AC-1 bacterial anodes included about 92% Proteobacteria. The organisms belonging to the phylum Proteobacteria related mainly to Geobacter (AC-1: 91%; A-1: 90%; non-immobilized: 73%). These results showed that the AC-1 and A-1 bacterial anodes had lower species diversity than the non-immobilized anode, indicating that the in-situ immobilization of the anode partially blocked the invasion and development of other microbial communities on the anode.

Luo et al. (2016) studied agarose immobilization on a bacterial anode in an MFC, where the diversity mainly consisted of Proteobacteria (68%), Bacteroidetes (16%), and Synergistetes (6.0%). In a non-immobilized anode MFC, 49% Proteobacteria, 15% Bacteroidetes and 15% Lentisphaerae were found. The comparative richness of Geobacter in the immobilized MFC was much higher than in the non-immobilized MFC (62% vs. 40%). The probable reason was that the average pore size inside 1% agarose gel is smaller than 0.5 μm; thus, it was more difficult for bacteria in the anolyte to invade the agarose gel. To summarize, immobilization of bacteria using organic polymers can prevent the invasion of non-desired bacteria into the anode.

TABLE 1
Microbial diversity in percentage of
total sequences at the phylum level

| | Bacterial anode | | |
|---|---|---|---|
| | Non-immobilized | A-1 | AC-1 |
| Phyla/MEC | (%) | (%) | (%) |
| Euryarchaeota | 5.46 | 0.472 | 0.034 |
| Acidobacteria | 0.005 | 0.240 | 0.330 |
| Actinobacteria | 0.037 | 0.000 | 0.011 |
| Bacteroidetes | 6.086 | 4.761 | 5.315 |
| Firmicutes | 0.304 | 0.207 | 0.330 |
| Proteobacteria | 74.338 | 91.504 | 91.656 |
| Spirochaetes | 0.427 | 0.149 | 0.000 |
| Synergistetes | 0.352 | 0.116 | 0.387 |
| Thermotogae | 12.980 | 2.546 | 1.935 |

### Example 7

SEM Analysis

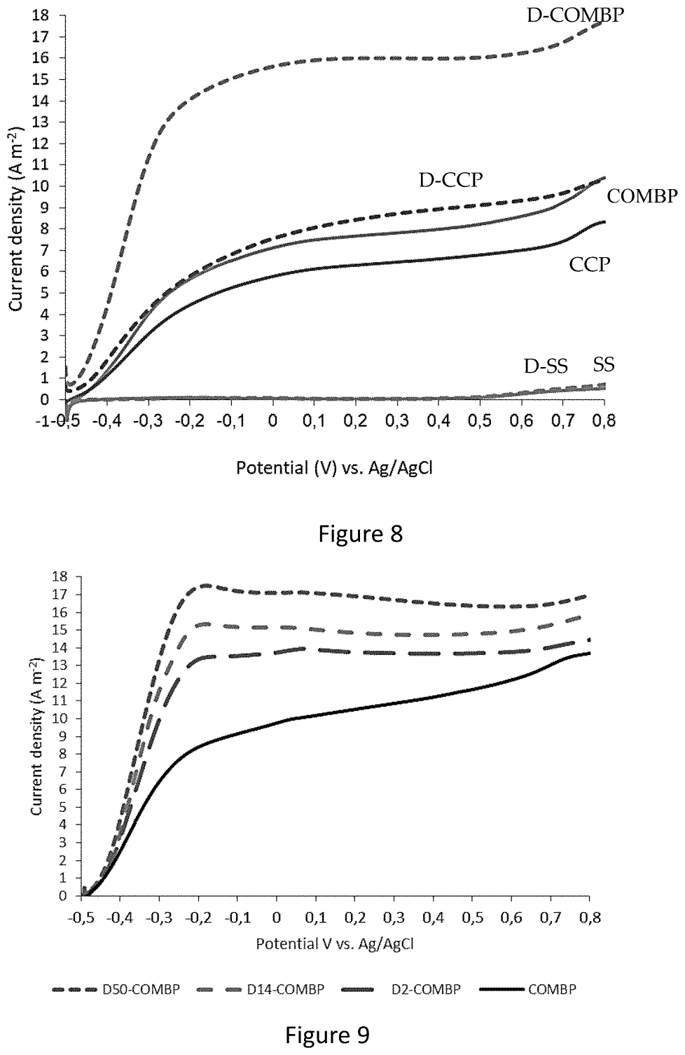

With the naked eye it was observed that the AC-1 and A-1 anodes were covered with brick-red bacterial cells and a layer of alginate, while the non-immobilized anode was covered with brick-red aggregate bacterial cells only. However, at the end of the MEC's operation (30 days), the anodes were visualized by SEM analysis. SEM images of immobilized and non-immobilized anode electrodes with a magnification of 150× and 1,000× are shown on the left side and on the right side of FIG. 7, respectively. SEM images of the non-immobilized anode showed bacterial aggregation on and between the carbon fibers. SEM analysis of the AC-1 and A-1 bacterial anodes showed a dense coating layer on the anode, which wasn't seen in the non-immobilized anode. Under this layer there was a developed biofilm.

### Example 8

LSV Measurements of MECs Based on: D-COMBP, D-CCP, DSS, COMBP, CCP and SS Bioanodes

Based on a previous study, SS anode material, which is known as a highly conductive and cost-effective metal, was compared to the common CC anode and used to prepare new anode configuration in which the CC and SS were tightly attached (COMB). In addition, cold nitrogen plasma used as an efficient surface treatment to increase biofilm growth and viability on combined COMB anodes (COMBP), that was comprised of untreated SS and plasma-treated CC anodes, and on CC anodes (CCP).

In this study, the inventors examined a new concept of increasing biofilm growth and viability by using dialysis bags for SS, CCP, COMBP microbial anodes enclosing.

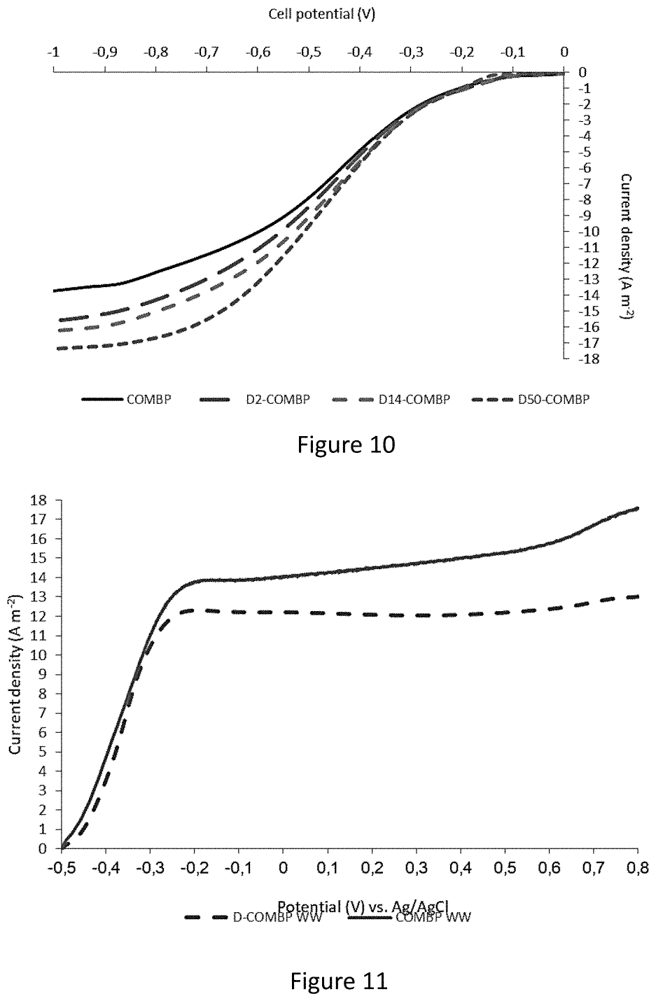

To increase biofilm growth and attachment, SS, CCP and COMBP anodes were inserted to dialysis bags as descript on methods, to form D-SSP, D-CCP and D-COMBP anodes, respectively. The MECs were inoculated with Geobacter and were operated under a chronoamperometry potential of 0.3V vs. Ag/AgCl. LSV measurement was performed on the 11^{th} day of the MEC operation (FIG. 8).

The results in FIG. 8 show that MEC dialysis growth anodes (D-CCP, D-SS and D-COMBP) produced higher currents compared to MECs based on non-dialysis same material and plasma treated anodes (CCP, SSP and COMB). Under an applied voltage of 0.6V vs. Ag/AgCl, the currents obtained in a MEC based on D-CCP and D-COMBP were 9.32 and 16.23 A·m⁻², respectively; while MEC based on non-dialysis carbon cloth (CCP and COMBP) yielded currents of only 7.01 and 8.59 A·m⁻², respectively. In the MEC with a D-SS and SS anodes, the observed current at an applied voltage of 0.6 V vs. Ag/AgCl, was only 0.32 and 0.27 A·m⁻², respectively.

Based on the LSV analysis, it was demonstrated that dialysis growth anodes (CCP and COMBP) led to higher currents when compared to the non-dialysis same material and plasma treated anodes (CCP and COMBP). The poor biofilm viability observed on SS that mainly served as an electron-current collector, rather than a material capable of supporting biofilm attachment, as previously described (Rozenfeld et al., 2019), rarely improved here by dialysis growth.

Previously, (Rozenfeld et al., 2019) it was shown that under an applied voltage of 0.6 V (Ag/AgCl), the currents of a MEC based on CCP and COMBP were 11.66±0.1331 and 16.36±0.3172 A·m⁻², respectively, which were about three times higher compared to the untreated CC and COMB. A MEC utilizing an untreated SS anode exhibited current of only 0.3712±0.0108 A·m⁻².

The inventors hypothesize that COMBP anodes that are made by combining two materials: CC with plasma treatment for better conditions of biofilm formation and the SS material to supported better current collection, can be improved by dialysis growth conditions while dialysis used as mechanical safe barrier. MEC bioanodes growth within enclosing dialysis bags with 2 kDa, 14 kDa, 50 kDa MWCO cut-off size, are compared to non-dialysis anodes.

### Example 9

Examination of the Oxidation Currents Contributed by the Planktonic Bacteria and by the Biofilm Anode in MECs Based on: D-COMBP, D-CCP, COMBP and CCP Anodes

The current contributed by each of the different active elements of the MEC to the overall obtained current was determined at the end of the MEC operation period. The oxidation currents generated by the full MEC construction were measured on the 21s^{t} day. The biofilm anode was transferred to a sterile MEC to examine currents contributed by the biofilm (the “biofilm anode”). A sterile anode was inserted into the MEC with the planktonic bacteria to measure the contribution of the planktonic bacteria to the obtained current of the full MEC (the “planktonic bacteria”). In addition, at the beginning of the MEC operation, the currents were measured before inoculation (the “abiotic anode”). The currents were measured when the MECs were operated under selected voltages of between 0.2 V to 0.8 V (Table 2).

TABLE 2
Recorded currents under applied voltages of 0.2 V-0.8
V. vs. Ag/AgCl, from MECs based on the different anodes
(D-COMBP, D-CCP, COMBP and CCP). Measurements were collected
from the fully constructed MEC, the biofilm anode, the
planktonic bacteria and the abiotic anode.

| | 0.2 V | 0.4 V | 0.6 V | 0.8 V | Onset potential |
|---|---|---|---|---|---|
| Electrode | (mA) | (mA) | (mA) | (mA) | (V vs. Ag/AgCl) |
| D-COMBP | 6.399 | 6.394 | 6.493 | 7.098 | −0.52 |
| D-CCP | 3.369 | 3.565 | 3.736 | 4.102 | −0.51 |
| D-SS | 0.023 | 0.026 | 0.129 | 0.286 | −0.455 |
| COMBP | 2 | 2.225 | 3.525 | 3.7 | −0.45 |
| CCP | 2.125 | 2.325 | 3.025 | 3.24 | −0.44 |
| SS | 0.018 | 0.023 | 0.113 | 0.216 | −0.442 |
| COMBP | 0.131 | 0.179 | 0.364 | 0.876 | −0.49 |
| plankton | | | | | |
| CCP plankton | 0.049 | 0.057 | 0.123 | 0.384 | −0.2 |
| SS plankton | 0.023 | 0.045 | 0.142 | 0.345 | −0.348 |
| COMBP control ¹ | 0.007 | 0.135 | 0.34 | 0.663 | −0.198 |
| CCP control ¹ | 0.006 | 0.011 | 0.021 | 0.049 | 0.002 |
| SS control ¹ | 0.053 | 0.113 | 0.28 | 0.457 | −0.283 |

¹ Abiotic electrode: Sterile anode inserted into a sterile medium as an experimental control

The MECs based on the different anodes were operated for 21 days. Increasing the voltage from 0.2V to 0.8V vs. Ag/AgCl led to higher currents in the four MECs (based on D-COMBP, D-CCP, D-SS, COMBP, CCP, SS anodes) as well as in each element (biofilm anode, planktonic bacteria, and abiotic electrode). The currents obtained under an applied voltage of 0.8V from the MEC based on the D-COMBP anode were the highest (7.098 mA), while the currents obtained from the MEC based on D-COMB and D-SS were 4.102 and 0.286 mA, respectively. The currents obtain by dialysis growth anodes D-COMBP, D-CCP and D-SS were 92%, 27% and 32% higher compare to currents obtain by non-dialysis same material anodes COMBP, CCP and SS, respectively (at 0.8V vs. Ag/AgCl).

In all cases, the biofilm anode contributed higher currents than the planktonic bacteria. For example, in the MEC based on the D-COMBP and COMBP anodes led to a current of 7.098 and 3.7 mA, while the planktonic bacteria on COMBP anode led to only 0.876 mA, lower than 8-fold and 4-fold, respectively.

New sterile set of COMBP, CCP, SSP anodes at abiotic fresh MEC used as abiotic control to estimate non-biofilm or non-planktonic production currents. For example, in the MEC based on the COMBP abiotic control led to a current of 0.663 mA while the planktonic bacteria increase to 0.876 mA (at 0.8V vs. Ag/AgCl).

The sum total of the currents obtained from the planktonic bacteria and from the biofilm anode did not equal the total current exhibited in the full constructed MEC. The inventors ascribed this phenomenon to damage occurring to the bacterial anode while moving it to a sterile MEC (Rozenfeld et al., 2019).

### Example 10

LSV Measurements of MECs Based on COMBP Bioanodes in Dialysis Enclosing Bags of 2 kDa, 14 kDa and 50 kDa MWCO Cut-Off

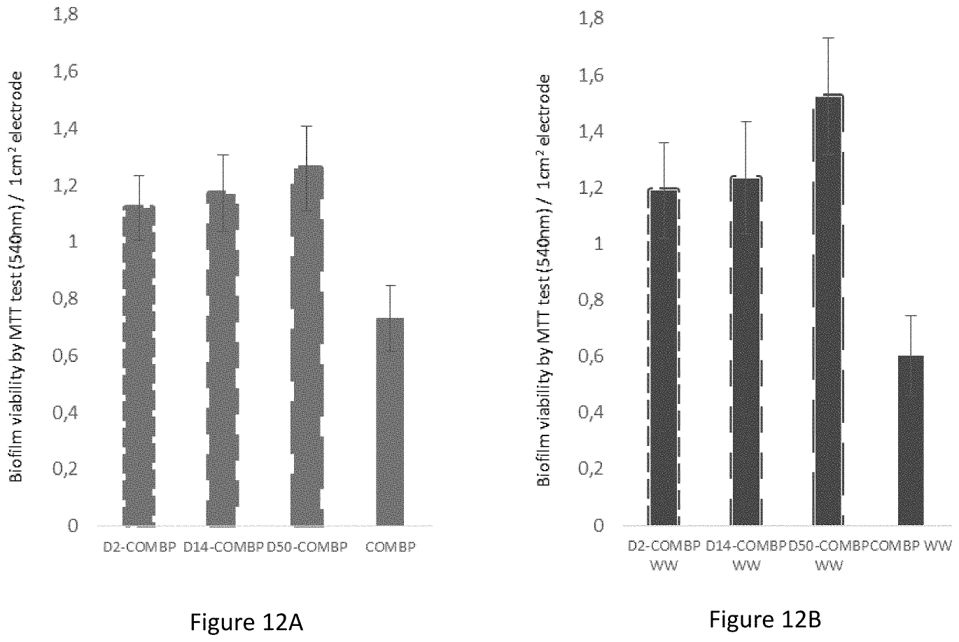

The results in FIG. 9 show that MECs based on COMBP bioanodes enclosing in dialysis bags (D2-COMBP, D14-COMBP and D50-COMBP) produced higher oxidation currents compared to non-dialysis same material with plasma treatment COMBP bioanode. Under an applied voltage of 0.6V vs. Ag/AgCl, the currents obtained in a MEC based on D2-COMBP, D14-COMBP and D50-COMBP were 13.79, 14.94 and 16.34 A·m⁻², respectively; while MEC based on non-dialysis COMBP yielded currents of only 12.19 A·m⁻².

From the LSV analysis, it can be demonstrated that enclosing dialysis growth anodes (D2-COMBP, D14-COMBP and D50-COMBP) led to higher currents as function of dialysis MWCO cut-off size.

### Example 11

Hydrogen Formation in the MECs

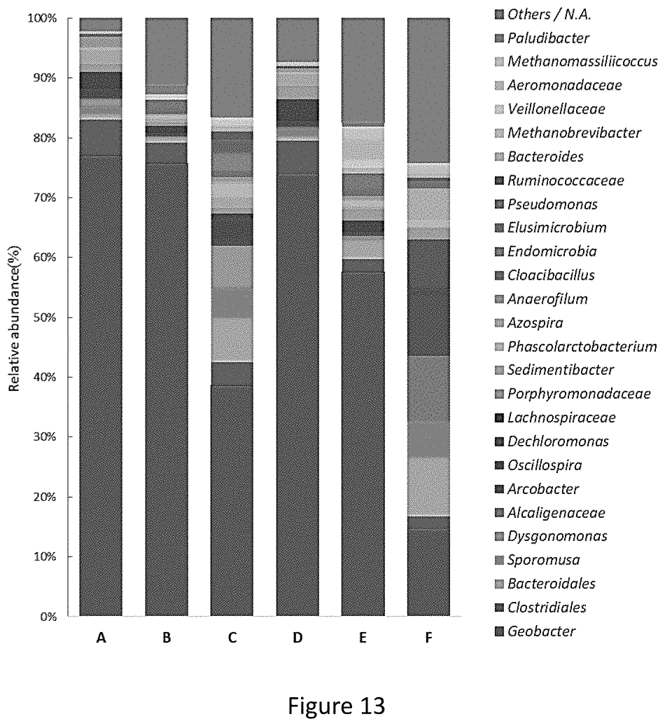

In the following experiments, the inventors examined the effect of the anode materials and surface plasma-pretreatment of the carbon cloth on HER. For these measurements (FIG. 10), the MECs were connected to the potentiostat in a configuration of 2 electrodes (the reference electrode was connected to the counter electrode).

The results depicted in FIG. 10 show that the highest hydrogen reduction currents of 17.38 A·m⁻² (at 1V) was obtained in the MEC applying the 50 kDa dialysis bags, D50-COMBP. At the maximal applied cell voltage (1V) the reduction current obtained in the MEC based on a D2-COMBP, D14-COMBP and D50-COMBP anode was 15.63, 16.23, 17.38 A·m⁻², respectively, while in the MEC based on a non-dialysis COMBP anode the maximal current was only 13.72 A·m².

Calculation of hydrogen evolution rates under applied constant potentials ranging from 0.2 to 1V were performed according to Equations 4-6, and results are presented in Table 2. Under an applied voltage of 0.6V, the current densities obtained in the MECs based on D2-COMBP, D14-COMBP, D50COMBP and COMBP anodes were 11.119, 11.920, 13.200 and 10.042 A·m⁻², respectively.

$${V}_{{H}_{2}} = \frac{I \times t \times R \times T}{z \times F \times P} , \qquad ( 4 )$$

wherein V_{H}_{₂}—Hydrogen production volume (m³·s⁻¹), P—gas pressure (atm), V—gas volume (m³), z—valence of element, R—the gas constant (0.0820577 L atm (mol⁻¹·K⁻¹), T—gas temperature (K), I—current (A), t—time (s), and F—Faraday's constant (96,485 C·mol⁻¹).

(5) Q(Vᵣ)_{H}_{₂}=V_{H}_{₂}(m³)×t(d⁻¹)×Vᵣ(m⁻³, wherein Q(Vᵣ)_{H}_{₂}—HER production rate per cubic meter of the anodic medium, V_{H}_{₂}—Hydrogen production volume (m³·s⁻¹, calculated from Equation 1), t—time in seconds normalized to 24 h, and Vᵣ—reactor volume normalized to cubic meter (m³).

(6) Q(Aₑ)_{H}_{₂}=V_{H}_{₂}(m³)×t(d⁻¹)×Aₑ(m⁻²), wherein Q(Aₑ)_{H}_{₂}—HER production rate per square meter of electrode, V_{H}_{₂}—Hydrogen production volume (m³·s⁻¹, calculated from Equation 1), t—time in seconds normalized to 24 h, and Aₑ—electrode geometric area normalized to square meter (m²).

TABLE 3
HER measurement of MECs based on D50-COMBP, D14-
COMBP, D2-COMBP, and COMBP (Cell potentials).

| | | | HER | HER |
|---|---|---|---|---|
| | | HER | production | production |
| | Applied | Current | rate ¹ | rate ² |
| | voltage | density | Q(vᵣ)_{H}_{₂} | Q(Aₑ)_{H}_{₂} |
| Anode | (V) | (A · m⁻²) | (m³ · d⁻¹ · m⁻³) | (m³ · d⁻¹ · m⁻²) |
| D2- | 0.2 | 1.0784 | 0.0408 | 0.0130 |
| COMBP | 0.4 | 5.1952 | 0.1965 | 0.0629 |
| | 0.6 | 11.119 | 0.4204 | 0.1345 |
| | 0.8 | 14.312 | 0.5412 | 0.1732 |
| | 1.0 | 15.631 | 0.5911 | 0.1891 |
| D14- | 0.2 | 1.1024 | 0.0417 | 0.0133 |
| COMBP | 0.4 | 5.5856 | 0.2112 | 0.0676 |
| | 0.6 | 11.920 | 0.4508 | 0.1442 |
| | 0.8 | 15.037 | 0.5685 | 0.1819 |
| | 1.0 | 16.227 | 0.6136 | 0.1964 |
| D50- | 0.2 | 0.976 | 0.0369 | 0.0118 |
| COMBP | 0.4 | 5.7392 | 0.2170 | 0.0694 |
| | 0.6 | 13.200 | 0.4992 | 0.1597 |
| | 0.8 | 16.683 | 0.6309 | 0.2019 |
| | 1.0 | 17.376 | 0.6571 | 0.2103 |
| COMBP | 0.2 | 0.960 | 0.0363 | 0.0116 |
| | 0.4 | 4.9072 | 0.1856 | 0.0594 |
| | 0.6 | 10.042 | 0.3797 | 0.1215 |
| | 0.8 | 12.567 | 0.4752 | 0.1521 |
| | 1.0 | 13.722 | 0.5189 | 0.1660 |

The results presented in Table 3 show that increasing the applied voltage from 0.2V to 1V resulted in a 17.8-fold, 14.7-fold and 14.5-fold enhancement of the reduction current density in MECs based on D50-COMBP, D14-COMBP and D50-COMBP, while, in MECs based on non-dialysis anode COMBP the reduction current density was increased by 14.3 fold.

In these MECs at 0.6V, the hydrogen evolution rates per cubic meter of the anodic medium were 0.4204, 0.4508, 0.4992 and 0.3797 m³·d⁻¹·m⁻³, respectively. The hydrogen evolution rates per square meter of anode at 0.6V were 0.1345, 0.1442, 0.1597 and 0.1215 m³·d⁻¹·m², respectively. These results show that under applied voltages of 1V, the MEC based on the D50-COMBP anode led to a highest hydrogen evolution rate of 0.6571 m³·d⁻¹·m⁻³, which is 7%, 11%, 27% over then rates of HER in the MECs based on D14-COMBP, D2-COMBP and COMBP, respectively.

In a previous study, the highest hydrogen production rate of 0.0736±0.0022 m³·d⁻¹·m⁻² and 0.2299±0.0069 m³·d⁻¹·m⁻³ at 0.8V were obtained in MECs based on the COMBP anode (Rozenfeld et al. 2019).

### Example 12

LSV Measurements of the D-COMBP and COMBP Bioanodes as a Function of WW as Carbon Sources

Almost any organic substrate can be employed in MECs ranging from simple carbohydrates, such as acetate to complex fermentable substrates such as biomass and wastewater.

Sodium acetate known as common carbon source for bacterial growth. As low-cost alternative, MECs with most effective COMB anode enclosed dialysis bag (D-COMBP) and without (COMBP) fed with wastewater.

One of the greatest advantages of MEC is the utilization of wastewater as the fuel leading to electricity generation as well as simultaneous wastewater treatment through simple hydrogen evolution reaction. The idea of utilizing microorganisms that are present in the substrate (in the case of wastewater) as the biocatalyst makes the process environment friendly and cost-effective.

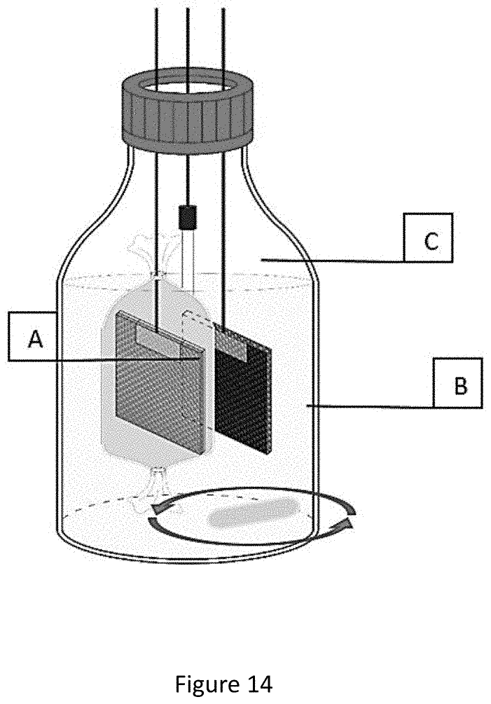

The MECs were inoculated with Geobacter and were operated under a chronoamperometry potential of 0.3V vs. Ag/AgCl. LSV measurement was performed on the 14^{th} day of the MEC operation (FIG. 11).

The results in FIG. 11 show that MEC dialysis growth anodes (D-CCP, D-SS and D-COMBP) produced higher currents compared to MECs based on non-dialysis same material and plasma treated anodes (CCP, SSP and COMB). Under an applied voltage of 0.6V vs. Ag/AgCl, the currents obtained in a MEC based on D-CCP and D-COMBP were 9.32 and 16.23 A·m⁻², respectively; while MEC based on non-dialysis carbon cloth (CCP and COMBP) yielded currents of only 7.01 and 8.59 A·m⁻², respectively. In the MEC with a D-SS and SS anodes, the observed current at an applied voltage of 0.6V vs. Ag/AgCl, was only 0.32 and 0.27 A·m⁻², respectively.

Bharath et at., shows that when acetate was used as the carbon source, the current density of a MEC based on non-immobilized anode was 10.95 A·m⁻², 15% higher compared to the immobilized bacterial anodes. When WW were used, the alginate with chitosan immobilized AC-1 bacterial anode led to the highest current density of 11.52 A·m⁻² at potential of 0.2V, 11% and 29% higher than the alginate immobilized A-1 anode and the non-immobilized anode, respectively.

### Example 13

Biofilm Formation on Bio-Anodes as a Function of Dialysis Enclosing (D2-COMBP, D14-COMBP, D50-COMBP and COMBP as Control) and Carbon Sources (Acetate and WW)

Biofilm formation on COMBP bio-anodes with enclosing in 2, 14 and 50 kDa dialysis cut-offs (D2-COMBP, D14-COMBP, D50-COMBP) and without dialysis enclosing (COMBP), as a control. The COMBP bioanodes growth in MECs under chronoamperometry 0.3V vs. Ag/AgCl for 20 days, first set with acetate and second set with WW, as a carbon source. At 30^{th} day, all bio-anodes ware washed with PBS, and the biofilm viability (normalized to 1 cm²) was measured by the calorimetric analysis, MTT (FIG. 6). In this assay, the inventors showed that hydrogenases of the biofilm community bacteria, reduced the MTT tetrazolium salt reagent to a purple solution that can be measured spectrophotometrically at OD₅₄₀.

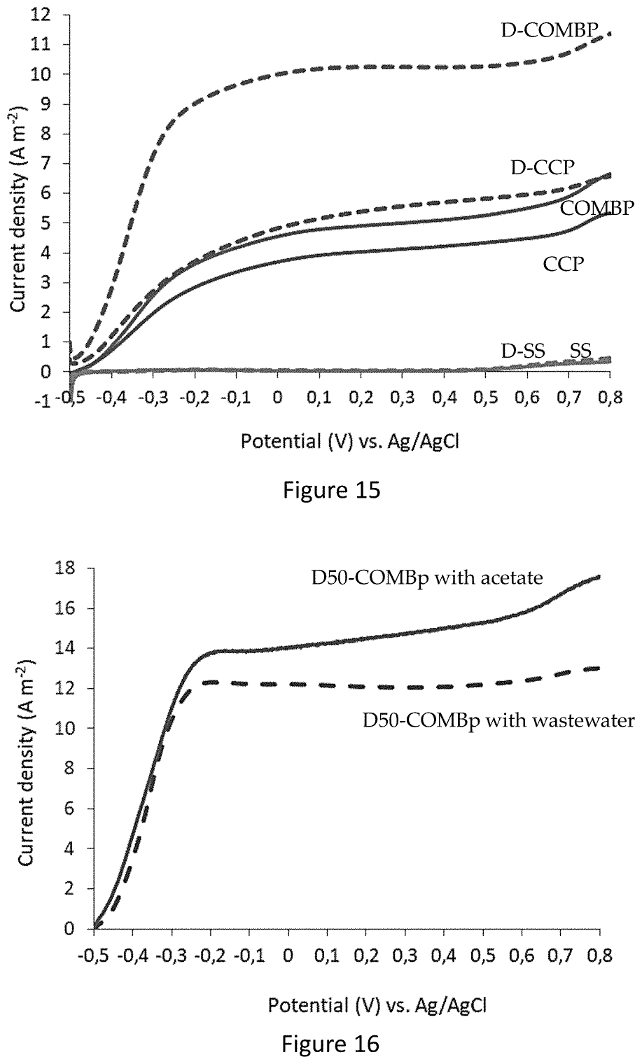

The results in FIG. 12 show the biofilm viability of biofilm microbial community, that obtained on COMBP electrodes enclosed at 2 kDa dialysis bag (D2-COMBP), 50 kDa dialysis bag (D50-COMBP) and non-dialysis COMBP bioanodes, as a control, that operated in MEC under acetate feeding and same set of electrodes that under WW feeding. From the results described in FIG. 12A, it can be seen that under acetate feeding the maximal biofilm viability of 1.26 OD₅₄₀±0.12 was developed on the on the D50-COMBP bioanode, compared to 1.71 OD₅₄₀±0.17, 1.12 OD₅₄₀±0.11 and only 0.73 OD₅₄₀±0.07 on the D14-COMBP, D2-COMBP and COMBP, respectively.

From the results described in FIG. 12B, it can be seen that under WW feeding, the maximal biofilm viability of 1.52 OD₅₄₀±0.15 was developed on the D50-COMBP WW bioanode, compared to 1.23 OD₅₄₀±0.12, 1.19 OD₅₄₀±0.11 and only 0.60 OD_{540±0.06} on the D14-COMBP WW, D2-COMBP WW and COMBP WW, respectively.

The biofilm viability on the enclosed dialysis bioanodes were higher by between 53%-153% then the non-dialysis same bioanode, depend on dialysis pore sizes and carbon source, thanks to effectivity of dialysis enclosed method for bioanodes, while the highest biofilm viability improvement of 153% was achieved on the D50-COMBP WW bioanode, due to the importance of the dialysis pore size to the carbon sources penetration in the wastewater feeding.

The biofilm viability on dialysis enclosed anodes under WW feeding (FIG. 12B) were significantly higher (p-value<0.05) compared to the same enclosed anodes under acetate feeding (FIG. 12A), particularly. These results can be obtained at MTT assay due to the big amount of microbial communities in the wastewater, while most of them were not exoelectrogenic active communities.

### Example 14

Microbial Diversity Analysis of Bioanodic Microbial Community Using 16S-rRNA

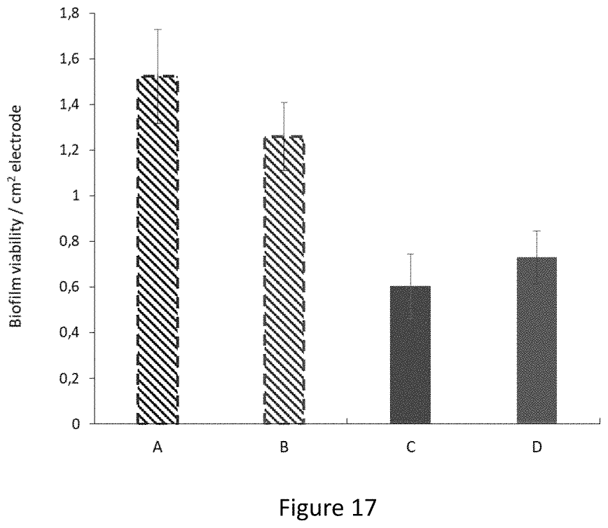

The total number of successfully aligned reads was 96,580 among the six samples (A-F in FIG. 13), that were represented by average relative abundance across samples. The rarity of Archaea in the obtained data was less than 0.7%, therefore, the inventors omitted this domain except for the methanogenic genus, and focused on the bacterial communities, especially on the genus Geobacter.

The compositions and relative abundances of 95 bacterial genera were identified with 27 major genera (by average relative abundance across samples), represented in FIG. 13. While non-dominant sequences with relative abundances of <1% or non-available was grouped as “Other/n.a.”.

The biofilm microbial community (genera) of COMBP bioanodes growth in dialysis enclosing under acetate (A) or wastewater as carbon source (B) compare to same anodes without dialysis enclosing, under acetate (D) or wastewater as carbon source (E), as a control of dialysis growth improvement. The planktonic genera in dialysis bags (C) compared planktonic genera without/outside dialysis enclosing (F).

The dominating genera of biofilms in dialysis enclosing under acetate as carbon source, were Geobacter (77.0%), Clostridiales (5.9%), Lachnospiraceae (2.8%), Sedimentibacter (2.3%), Anaerofilum (1.7%), Oscillospira (1.6%), Porphyromonadaceae (1.3%), and few others (7.4%, less than 1.2% each).

The dominating genera of biofilms in dialysis enclosing under wastewater as carbon source, were Geobacter (75.6%), Clostridiales (3.4%), Pseudomonas (1.4%), Paludibacter (1.4%), Lachnospiraceae (1.2%), and dozen others (17%).

Compared to dialysis enclosing, non-dialysis same anodes used as a control to dialysis improvement. Under acetate as a sole carbon source, the dominating genera of biofilm were Geobacter (73.9%), Clostridiales (5.6%), Lachnospiraceae (3.5%), Porphyromonadaceae (2.3%), Sedimentibacter (1.9%), Paludibacter (1.4%), Pseudomonas (1.3%), and few others (11.1%, less than 1.2% each), with big similarity to dialysis enclosed anode under acetate too. In contrast, under wastewater carbon source, the domination of Geobacter at the biofilm community decreased to 57.6%, Bacteroidales (3.1%), Aeromonadaceae (3.0%), Pseudomonas (2.4%), Methanomassiliicoccus (2.4%), Clostridiales (2.2%), Lachnospiraceae (1.8%), Porphyromonadaceae (1.8%), Veillonellaceae (1.4%), and dozen others (24.3%, less than 1.2% each).

Compared to dominating genera on biofilm, the domination of Geobacter at the planktonic community inside dialysis enclosing was 38.6%, while the planktonic community outside dialysis enclosing was only 14.7%. The other dominating genera at planktonic microbial community were Bacteroidales (7.3% inside, 9.9% outside), Sporomusa (4.9% inside, 6.0% outside), Clostridiales (3.9% inside, 2.0% outside), Dysgonomonas (7.2% inside, only 0.2% outside), Oscillospira (3.6% inside, 0.8% outside), Alcaligenaceae (0% inside, 10.7% outside), Arcobacter (0.9% inside, 10.3% outside), Dechloromonas (0.3% inside, 8.2% outside), Azospira (0.4% inside, 5.2% outside), and few dozen other (>32%, less than 1.2% each).

As shown in FIG. 13, the majority of genera on the anode biofilm and planktonic community at MEC bioanode, included Geobacter (14%-77%), Clostridiales (2%-5.9%), and especially planktonic genus Alcaligenaceae (up to 10.7%), Arcobacter (up to 10.3%), Bacteroidales (up to 9.9%), and Sporomusa (up to 6.0%), while each of the others genera was not markedly different.

### Example 15

LSV Measurements of MECs Based on Anodes Encapsulated in Dialysis Bags with a Pore Size of 50 kDa

Low hydrogen production in MECs is mostly attributed to the bacterial anode's poor bioelectroactivity, where one of the main problems is the invasion and attachment of non-exoelectrogenic bacteria. This is especially the case when the MEC is operated for a prolonged period with wastewater.

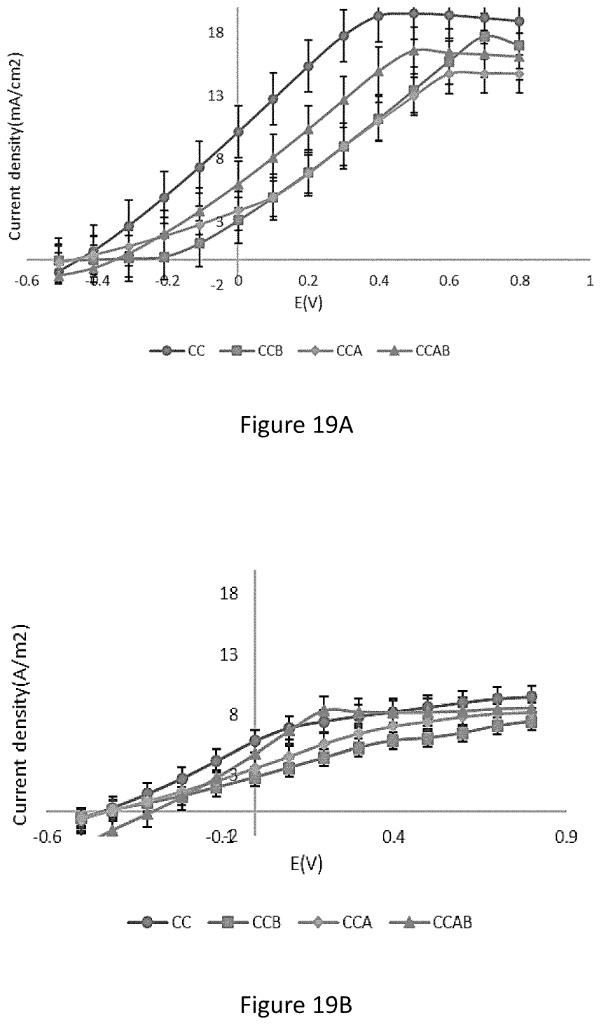

In this study, the inventors examined a new concept of encapsulating the MEC anode in a dialysis bag, where G. sulfurreducens inoculation was introduced directly into the dialysis bag. Our hypothesis was that encapsulation of the anode may prevent or reduce attachment of non-desirable bacteria to the exoelectrogenic bacterial anode. In addition, we assumed that inoculation of exoelectrogenic bacteria into the small volume enclosed by a dialysis bag may reduce the initial period of biofilm formation. A set of semi-single-chamber MECs based on platinum-coated CC cathodes and SS, CCp or COMBp anodes encapsulated in dialysis bags (MWCO of 50 kDa), were constructed and designated as D50-SS, D50-CCp, and D50-COMBp, respectively. MECs with the same anode materials but without encapsulation served as controls, designated as SS, CCp, and COMBp, respectively. The MECs based on the non-encapsulated anodes were inoculated with 10 mL G. sulfurreducens (0.35 OD±0.05); the MECs with the encapsulated anodes were inoculated with the same OD and volume, but directly into the dialysis bag. The MECs were fed with Geobacter medium containing acetate as the carbon source, and were maintained under external 0.3V vs. Ag/AgCl. On the 11^{th} day of the MECs' operation, LSV measurement was performed (FIG. 15).

The results depicted in FIG. 15 show that the MECs based on the encapsulated anodes (D50-CCp and D50-COMBp) led to higher currents, compared to the MECs with the non-encapsulated anodes (CCp and COMBp). Under an applied voltage of 0.6V vs. Ag/AgCl, the currents of the MECs utilizing the D50-CCp and D50-COMBp anodes were 5.97 and 10.39 A m⁻², respectively, while the MECs with the non-encapsulated anodes (CCp and COMBp) yielded currents of only 4.49 and 5.50 A m⁻², respectively. In the MECs with the D50-SS, as well as the non-encapsulated SS anodes, the observed currents (applied voltage of 0.6V vs. Ag/AgCl) were only 0.178 and 0.176 A m⁻², respectively.

In a previous study, the inventors reported that biofilm formation on SS was 7-fold lower compared to the biofilm on a CCp anode. However, utilizing a SS anode in combination with CCp (COMBp) led to a hydrogen production of 1.2-fold and 15-fold higher (at 0.6V), compared to only CCp and SS, respectively. It seems that SS is an ideal material for current collection rather than for biofilm formation. Several other studies showed that coating SS anodes with the conductive polymer polyaniline improved the electro activity of BES facilities.

### Example 16

The Contribution of the Bacterial Anode and the Planktonic Bacteria to the Overall Obtained Oxidation Currents, in the Different MECs

In this experiment, the inventors examined the oxidation currents of the bacterial anode (the biofilm on the anode) and the planktonic bacteria in MECs based on the encapsulated anode. D50-SS, D50-CCp, and D50-COMBp anodes were inoculated with G. sulfurreducens in Geobacter medium with acetate as the carbon source, and were operated for 21 days. Measurements of the obtained currents at selected applied potentials in the range of −0.4V-0.8V vs. Ag/AgCl were collected from the full MEC construction, the bacterial anode, the planktonic bacteria (Table 4), and the abiotic anode. The abiotic anode was the measured oxidation current of a sterile anode in sterile medium before the MEC inoculation. The oxidation currents of the full MECs were measured on the 21^{st} day (full MEC configuration). After transferring the bacterial anode to a sterile MEC, the inventors measured the oxidation currents of only the bacterial anode. Measurement of the planktonic bacteria was performed by inserting a sterile anode into MEC containing planktonic bacteria which were released from the dialysis bag.

TABLE 4
Recorded currents at selected applied potentials in the range of −0.4 V-0.8
V. vs. Ag/AgCl, from the fully constructed MECs based on the encapsulated anodes
(D50-COMBp and D50-CCp), the bacterial anode and the planktonic bacteria.

| | | Applied voltage | | | | | | | |
|---|---|---|---|---|---|---|---|---|---|
| | | −0.4 V | −0.2 V | 0 V | 0.2 V | 0.4 V | 0.6 V | 0.8 V | Onset |
| | | Current | Current | Current | Current | Current | Current | Current | potential |
| Current source | Electrode | (mA) | (mA) | (mA) | (mA) | (mA) | (mA) | (mA) | (V vs. g/A_{g}Cl) |
| Complete MEC | D50-COMBp | 1.732 ± | 5.628 ± | 6.244 ± | 6.399 ± | 6.394 ± | 6.493 ± | 7.098 ± | −0.52 |
| configuration | | 0.129 | 0.134 | 0.204 | 0.214 | 0.219 | 0.289 | 0.396 | |
| | D50-CCp | 0.739 ± | 2.315 ± | 3.018 ± | 3.369 ± | 3.569 ± | 3.729 ± | 4.116 ± | −0.51 |
| | | 0.142 | 0.269 | 0.353 | 0.423 | 0.465 | 0.463 | 0.392 | |
| Bacterial | D50-COMBp | 0.541 ± | 2.265 ± | 2.848 ± | 3.069 ± | 3.196 ± | 3.437 ± | 4.160 ± | −0.45 |
| anode | | 0.089 | 0.126 | 0.231 | 0.243 | 0.298 | 0.347 | 0.363 | |
| | D50-CCp | 0.455 ± | 1.777 ± | 2.312 ± | 2.523 ± | 2.640 ± | 2.803 ± | 3.332 ± | −0.44 |
| | | 0.096 | 0.146 | 0.252 | 0.249 | 0.267 | 0.329 | 0.359 | |
| Planktonic | COMBp | 0.038 ± | 0.027 ± | 0.061 ± | 0.060 ± | 0.075 ± | 0.209 ± | 0.573 ± | −0.31 |
| bacteria | | 0.015 | 0.012 | 0.026 | 0.028 | 0.039 | 0.063 | 0.101 | |
| | CCp | 0.143 ± | 0.006 ± | 0.027 ± | 0.052 ± | 0.054 ± | 0.095 ± | 0.182 ± | −0.22 |
| | | 0.035 | 0.003 | 0.011 | 0.025 | 0.024 | 0.032 | 0.053 | |

The results in Table 4 show that increasing the voltage from −0.4V to 0.8V vs. Ag/AgCl led to gradual current incremental increases in all the MECs, and in each of their elements (biofilm anode and planktonic bacteria). The fully constructed MEC based on the D50-COMBp anode led to the highest currents (7.098±0.396 mA at 0.8V vs. Ag/AgCl), while the current obtained from the full MEC construction based on the D50-CCp was only 4.116±0.392 mA. The MECs based on the D50-SS and SS anodes led to negligible currents.

In all the cases, the bacterial anodes contributed the greater portion of the obtained currents, compared to the planktonic bacteria. For example, in the MEC based on the D50-COMBp under an applied voltage of 0.8V, the bacterial anode contributed 59% to the overall current, while the planktonic bacteria contributed only 8%. A similar phenomenon was observed in the MEC based on the D50-CCp anode: the bacterial anode contributed 81% to the overall current, while the planktonic bacteria contributed only 4%. The abiotic anodes in all cases led to very low currents, around 0.04±0.02 mA. The sum of the currents obtained from the bacterial anode and the planktonic bacteria did not equal the total current exhibited in the fully constructed MEC. The inventors saw this phenomenon also in another study and ascribe it to damage occurring to the bacterial anode while moving it to a sterile MEC.

A close examination of the results listed in Table 4 reveals the low onset potentials of the D50-COMBp and D50-CCp (˜−0.51V) in their full configuration. When the bacterial anode was transferred into a sterilized chamber, the onset potential increased to 0.45V; a further increment was observed (−0.22V and −0.31V, respectively) when sterilized CCp and COMBp anodes were inserted into the anode chamber containing planktonic bacteria. These experiments were designed to evaluate contributions from the biofilm and planktonic cells to the total current yield of the studied anodes. The low overpotential agrees with the higher current seen in the full cells, justified more by the highly active biofilm than by the planktonic cells. However, the close onset potential can only serve as an indication of the anode activity at low potentials, not at higher current and voltage output demand. At higher potentials, the anode currents depend on also charge transfer (at first) and mass transfer (at higher potentials), as well as current collection resistance, all of which are translated to total internal resistance. Therefore, the current output seen in the D50-COMBp based reactor is superior to that of the D50-CCp.

In our study, the concept of encapsulating the anode by dialysis bag was adopted to reduce the attachment of non-electrogenic bacteria to the biofilm on the bacterial anode.

### Example 17

LSV Measurements of MECs Applying the Encapsulated Anode D50-COMBp and the Non-Encapsulated COMBp Anode, which were Fed with Acetate or Wastewater

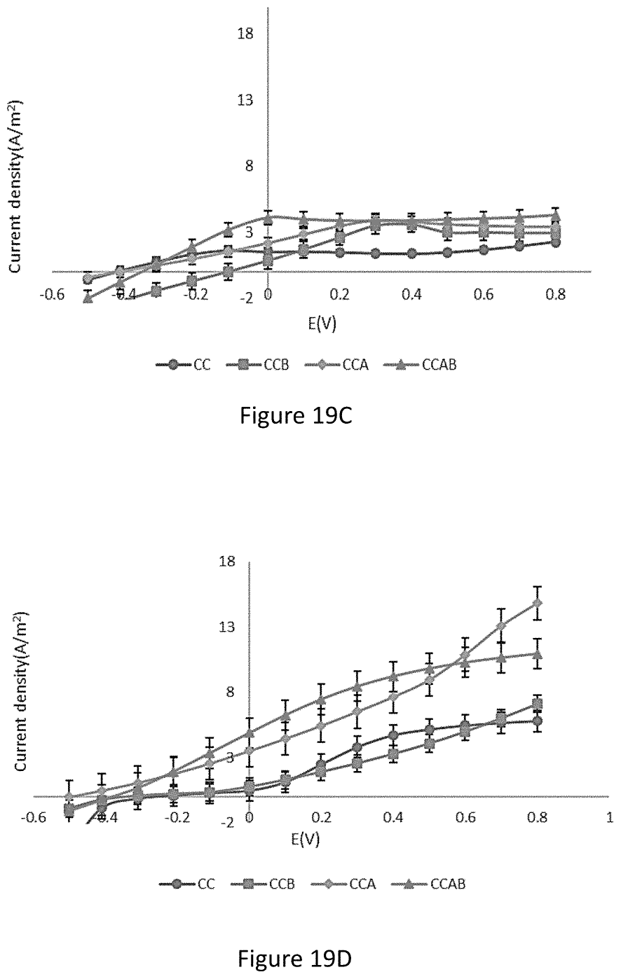

In the presented experiment, the electroactivity of the MECs based on the encapsulated D50-COMBp anode was examined when the cells were inoculated with acetate vs. wastewater. The MECs were operated under a constant potential of 0.3V vs. Ag/AgCl; on the 27^{th} day, LSV measurements were performed (FIG. 16).

The results in FIG. 16 show that under the applied voltage of 0.6V vs. Ag/AgCl, the MEC inoculated with acetate as the carbon source led to the highest current density of 15.7 A m⁻², while in the MEC that was inoculated with wastewater the current density was only 12.4 A m⁻². We assume that the relatively low current in the latter MEC was due to a lower percentage of G. sulfurreducens in the biofilm anode. In addition, there were probably limitations in proton transfer through the dialysis bag pores, due to biofouling.

### Example 18

Biofilm Viability of the Encapsulated and Non-Encapsulated COMBp Anodes, when the MECs were Fed with Acetate or Wastewater

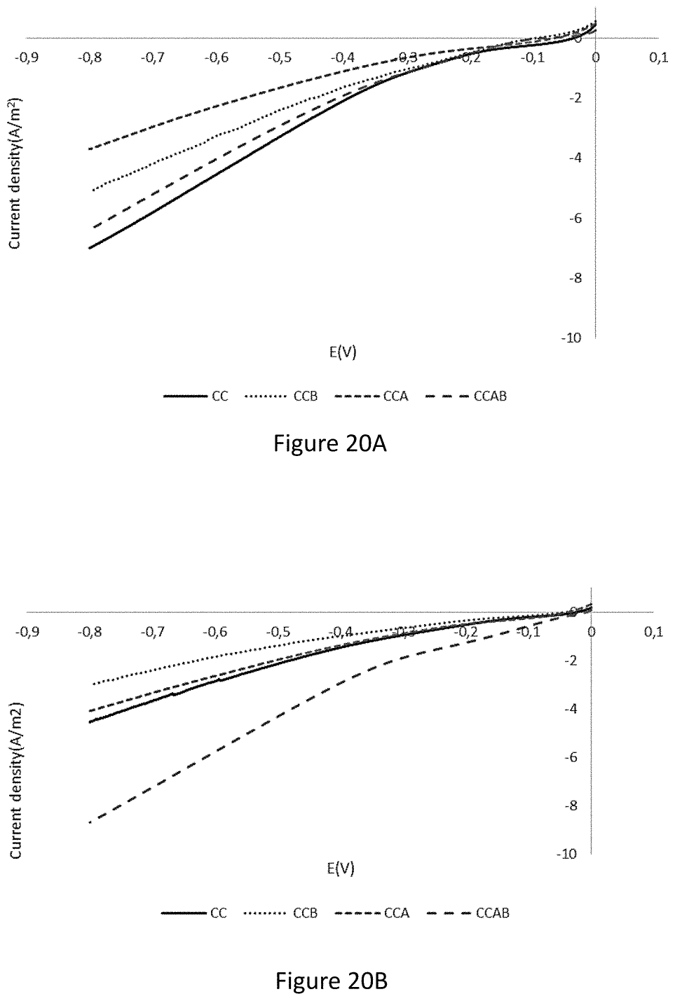

The biofilm viability of the encapsulated bacterial anodes vs. the non-encapsulated anodes was examined using MTT analysis. This assay is based on the bacterial hydrogenases in the biofilm anode that reduce the tetrazolium salt reagent to a purple color. The subsequent solubilization of the reduced reagent to a solution can be measured using a spectrophotometer. The MECs applying the D50-COMBp and the non-encapsulated COMBp anodes were inoculated with G. sulfurreducens and used acetate as the carbon source. On the 20^{th} day, four sets were fed with wastewater while four sets were continued with Geobacter medium containing acetate. At the end of the MECs' operation, on the 30^{th} day, the viability of the bacterial anodes was investigated after gently washing with PBS (FIG. 17). Each of the anodes was examined by MTT analysis. The intensity of the purple solution was examined using a spectrophotometer, and the results were normalized for 1 cm² anode.

The results in FIG. 17 show that the biofilm viability of the encapsulated anodes (D50-COMBp) were about the same (1.25 OD±0.15 and 1.53 OD±0.21; P value<0.08) regardless to the organic matter source (acetate or wastewater). However, there is a significant difference between the encapsulated anodes when the MEC s were inoculated with acetate or wastewater: these were 1.7-fold and 2.5-fold higher, respectively, when compared to the non-encapsulated anodes.

### Example 19

Microbial Diversity of the Bacterial Anode

The MECs based on the encapsulated anode (D50-COMBp) and the non-encapsulated anode (COMBp) were fed only with acetate for 30 days; or for 20 days with acetate, followed by feeding for 10 days with wastewater (total operation 30 days). The microbial diversity of each anodic biofilm and the planktonic bacteria was evaluated based on 16S rRNA. Operational taxonomic unit (OTU) readings were identified and phylogenetically classified. Unidentified species or sequences with relative abundances of <1% were grouped as “Other/N.A.” (FIG. 17). A total of 11 distinct phyla were identified in all of the four samples. Regarding the dominant genera, 26 were identified among the planktonic bacteria: 16 in the non-encapsulated anode and 12 in the encapsulated anode when the MEC was fed with wastewater; and 10 when fed with acetate (not including unidentified species or sequences with relative abundances of <1%). In the four samples, the dominant phylum was Proteobacteria. When the MEC was fed with acetate, the encapsulated anode biofilm included 78% Proteobacteria (mainly G. sulfurreducens 77%), 16% Firmicutes, 4% Bacteroidetes and −2% others. When the MEC was fed with wastewater, the encapsulated anode biofilm included 73% Proteobacteria (mainly G. sulfurreducens 70%), 8% Firmicutes, 4% Bacteroidetes and −15% others. The non-encapsulated bacterial anodes included about 73% Proteobacteria (mainly G. sulfurreducens 58%), 6% Firmicutes, 4% Bacteroidetes and −17% others. Meanwhile, the planktonic bacteria included 40% Proteobacteria (G. sulfurreducens 13%), 10% Firmicutes, 15% Bacteroidetes and −35% others.

### Example 20

Advanced Stabilized Bacterial Anode Using Alginate Encapsulated by Filter Bags for Hydrogen Production in Bio-Electrochemical Cell

### Materials and Methods

### Microbial Culture

G. sulfurreducens (DSMZ12127) was grown in Geobacter medium (N′ 826, DSMZ Germany) with an inoculum of 2 ml in each serum bottle with OD of 0.6 at 600 nm. 23 borosilicate glass serum bottles in an 80% N2: 20% CO₂ atmosphere were incubated with shaking (120 rpm) for about 5-6 days at 30° C., until prominence of red bacterial aggregates were formed (Rozenfeld et al., 2018). The well-cultivated Geobacter cultures represent an OD of 0.8 at 600 nm were used.

### Treatment of Carbon Textile Using Cold Low-Pressure Nitrogen Plasma

The 16 number of woven carbon cloth (2.5 cm×2.5 cm) (Fiber Fabric Parex 30-Fuel Cell Store, USA) were treated with cold low-pressure nitrogen plasma using a plasma cleaner system (Harrick PDC-32G-2, USA, RF of 60 Hz, power of 18 W) for 2 minutes at a pressure of 0.6 torrs. Followed by connecting the carbon textile pieces to titanium wires. There after applied silica gel to bind titanium wire and carbon cloth pieces. The electrodes were washed with demineralized water to preserve the hydrophilic nature of the carbon cloth surface (Bormashenko et al., 2013). These plasma-treated carbon cloth connected to titanium wire were used as an anode for the bioanode development.

### Bioanode Development

For developing same bacterial biofilm on all the bioanodes, the plasma treated electrodes were added to a single chamber MEC for 10 days. The plasma treated carbon cloth anodes along with the titanium wires were inserted to a closed, single-chamber MEC with a volume of 200 ml. The MEC also contains platinum-coated carbon cloth with titanium wire as the cathode and an Ag/AgCl reference electrode (ALS Co. Ltd, Japan). The MEC cell was filled with Geobacter medium and connected to the potentiostat. 10% of Geobacter medium with 0.9 OD G. sulfurreducens culture was added to the MEC cell. The MEC was maintained at 35° C. for two weeks under a constant voltage of 0.3V vs. Ag/AgCl reference electrode, in which the nitrogen-sparged Geobacter medium was replaced with a fresh one every five days. After the acclimation period, the current of each anode (16 number) was nearly ±0.32 mA/cm² (2 mA). 12 anodes were immobilized and the remaining 4 were served as controls (CC). Each of these anodes was placed in an individual MEC cell.

### Immobilization of the Bioanodes

Three different sets of immobilized bioanodes were prepared. In the first set, the bioanode (plasma-treated carbon textile plus pre-acclimatized G. sulfurreducens) was inserted into a white color nylon bag (pore size of 25 μm; Company Dulytek; Dimensions: 40*130 mm) (CCB). In the second set, the bioanode was immobilized using sodium alginate (CCA). In this step, 3% sodium alginate was added to 10 ml of sterile hot distilled water and stirred for 10 minutes. After cooling the alginate solution, the pre-acclimatized bioanodes were immersed in alginate solution and allowed to settle for one minute. Immediately afterward, these bioanodes were transferred to a sterile 100 mL BaCl₂ (0.1 M) solution for polymerization the alginate on the bioanode. The bioanodes were left for one hour to complete the gelatinization process under anaerobic conditions by sparging a mixture of N₂ and CO₂ gas. The alginate-coated bioanode was rinsed with sterile Geobacter medium to remove unnecessary particles. In the third set, the pre-acclimatized bioanode was immobilized using sodium alginate as mention above but followed by inserting in to a nylon bag (CCAB). Each set contained three replicates

### MEC Set-Up and Electrical Measurement Using Immobilized Bioanode and Non-Immobilized Bioanode

A single-chamber MEC was constructed using glass bottles (ISO LAB, Germany) with a total volume of 100 ml and 90 ml working volume. The bottles were sealed with a screw cap and GL-45 silicone rubber septa stoppers (SCHOTT AG, Germany). One side platinum (Pt-0.5 mg cm⁻²) coated carbon cloth (2.5 cm×2.5 cm) was used as a cathode (Fuel Cell Store, USA). The, immobilized (CCB, CCA, CCAB) and non-immobilized (CC) (control) electrodes were used as the anode (Briefly discussed in above section). The anode and cathode were placed parallel to each other and separated by a polypropylene spacer net. Titanium wires were used as a conductive material for working and counter electrodes. An Ag/AgCl electrode (3.0 M KCl) (+199 mV vs SHE) (ALS Co., Ltd, Japan) was used as the reference electrode. The MECs were filled with Geobacter medium and sodium acetate (10 mM) or wastewater (WW) (800 to mg/L COD) as the carbon source. The MECs were incubated at a temperature of 35° C. The MEC cells were placed on a magnetic stirrer for constant electrolyte stirring at 120 rpm. The duration of the experiment is five weeks, to provide adequate time for the development of bacteria and the investigation of bioelectrochemical activities.

### Microbial Community Analysis

Microbial community analysis was conducted by Hylabs Private Limited in Israel. DNA was extracted using the DNeasy Powersoil kit (Qiagen) according to the manufacturer's instructions. The preparation of the 16s library for sequencing on Illumina was performed using a 2-step PCR protocol. In the first PCR, the v4 region of the 16s rRNA gene was amplified using the 16s 515F and 806R from the Earth Microbiome Project with CS1 and CS2 tails. A second PCR was performed using Fluidigm Access Array primers for Illumina to add the adapter and index sequences. Sequencing was done in Illumina Miseq using the v2-500 cycles kit to generate 2×250 paired-end readings. Demultiplexing was done in BaseSpace (Illumina Cloud) to create FASTQ files for each sample. Data were analyzed using CLC-bio to make OTU and abundance tables.

### Analyzing Methods

MultiEmStat3+ potentiostat (PalmSense, Netherlands) was connected to the MEC in a 3-electrode configuration. Potentiostatic control was maintained by poising the anode to +0.3V vs. Ag/AgCl (3.0 M KCl). Linear sweep voltammetry (LSV) has been performed in the potential range of −0.5 to 0.8V and the scan rate of 5 mV/s to obtain mechanical and phenomenological data of the processes occurring in the system (Logan et al., 2006). Differential pulse voltammetry (DPV) was applied to the same potential range to determine the current-voltage (I-V) curve under semi-steady-state. Chemical oxygen demand (COD) and pH were determined using APHA standard methods (APHA, 1998). COD was determined using a colorimetric based closed reflux COD digester (MRC Labs, China), and the pH was established with a pH meter. Electrochemical tests were performed using MultiEmStat3+ potentiostat (Palmsens). The hydrogen production rate is measured in a 2-electrode configuration, in the range of 0.2 to 0.8V below the applied constant potential. The rate of hydrogen production is calculated according to 1 and 2 (Rozenfeld et al., 2018).

Q_{H}_{₂}=V_{H2}[m³]×t[d⁻¹]×Vᵣ[m⁻³] (1)

Here, V_{H2} is the Volume of hydrogen production (m³); t=time (seconds/day); Vr is the Volume of the reactor in m³.

$${V}_{{H}_{2}} = \frac{I \times t \times R \times T}{k \times F \times P} \qquad ( 2 )$$

where I—Current (A); t—Time (s); R—Gas constant (0.0820577 L atm (mol⁻¹ K⁻¹); T—temperature (K); k—valence number of substrate; F—Faraday's constant (96,485 C mol⁻¹); P—H₂ Gas pressure (atm).

### Results and Discussion

DPV and LSV Measurements of the Stabilized Alginate Bacterial Anodes Encapsulated with Nylon Bag, in MECs Inoculated with Acetate and WW

The current and hydrogen production in MECs based on the pre-prepared bacterial anodes made of a carbon cloth with biofilm (CC), carbon cloth with biofilm encapsulated with nylon bag (CCB), carbon cloth with biofilm covered with alginate (CCA) and carbon cloth with biofilm covered with alginate as well as encapsulated with nylon bag (CCAB) were examined when the MECs were fed with acetate or WW. The measurements were performed on the 21^{st} day of the MECs which were fed with acetate (800 mg/L COD) as well as on the 30^{th}, 36^{th} days when the feeding was acetate and WW with different dilutions (2:1, 1:1) (800 mg/L COD), and on the 43^{rd} day where the MECs were fed with only WW (896 mg/L COD). The bacterial anodes LSV measured at 14 potentials (between −0.5 to 0.8V vs. Ag/AgCl), with a scan rate of 5 mV/s.

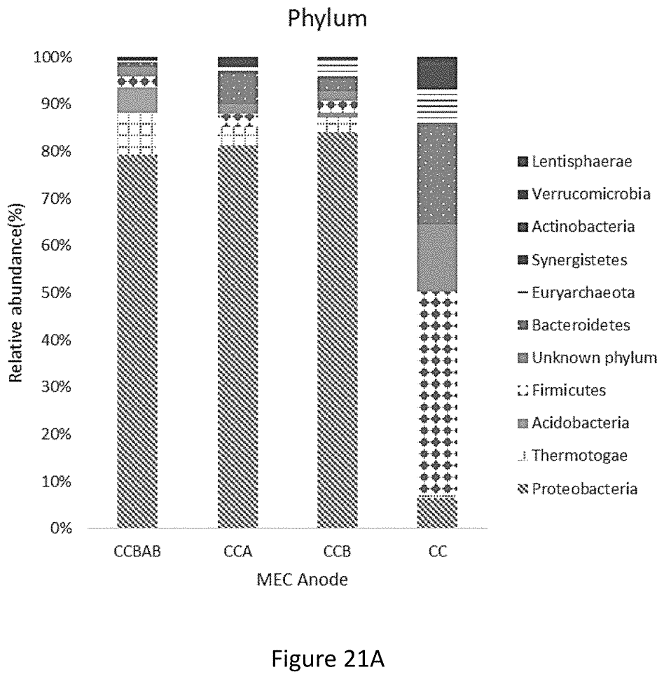

The LSV measurements were performed on the 21th day (FIG. 19A) in MECs that were fed with acetate with (COD concentration of 800 mg/L). The highest current density value 19.37 A m⁻² observed at 0.4V in CC bacterial anode. The current densities of the immobilized anodes CCB, CCA and CCAB were 11.19 A m⁻², 11.35 A m⁻² and 14.99 A m⁻². The non-immobilized anode CC had 28%, 17% more current densities compared to the CCAB anode at different potentials like 0.4V, 0.5V and 0.7V. The plateau curve of all measured bacterial anodes occurred at the highest measured potential for each anode up to 0.8V. The onset of the CC anode was −0.4 while for CCAB it was at −0.3V. From the results of FIG. 19A it can be seen that when the MEC was fed with acetate the higher electroactivity was obtained by the nonencapsulated anode (CC).

LSV measurements on the 30^{th} day were done when the MECs were fed with acetate and WW in a ratio of 2:1 (532 and 266 mg/L COD, respectively) (FIG. 19B). Adding the WW led to a decrease in the current densities of all the anodes. At potentials of 0.2 to 0.8V, the current densities of the CC were very similar to that of the CCAB (·9 A m⁻²). In the CCAB bacterial anode, the maximum current density was 8.59 A m⁻² at the applied voltage of 0.8V but plateau was started at 0.2V. The CCB and CCA anode showed a maximum current density of 7.42 A m⁻², 8.17 A m⁻² at an applied potential of 0.8V.

LSV measurements on the 36^{th} day when the MECs were fed with acetate: WW with the ratio of 1: 1 (COD concentration was 800 mg/L) (FIG. 19C) show that the current densities of all the bacterial anodes led to lower current densities compared to the 30^{th} day. In addition, all the anodes had a plateau curve from their potential of the highest current density up to 0.8V. The highest current density was obtained by the CCAB anode, at 0V, it was 4.09 A m⁻². While the CC anode reached its highest current density at 0.8V where it was only 2.26 A m⁻².

LSV measurements on the 43th day when the MECs were fed with only wastewater (COD of 896 mg/L) (FIG. 19D) shows that at an applied potential of 0.8V the CC, CCB, CCA and CCAB bacterial anodes led to current density value of 5.80, 7.12, 14.82 and 10.93 A m⁻², respectively, but the plateau stars from 0.4V in the CCAB. For summary, CCA led to the highest current density at an applied voltage of 0.8V. But, at lower applied voltage of 0.4V, the CCAB anode led to the highest current density of 9.21 A m⁻² which is 20%, 95%, 180% higher compared to CCA, CC and CCB, respectively. These results also confirmed by DPV under steady-state conditions for 300 s at each potential.

The LSV measurement values at different potentials is summarized in Table 5.

TABLE 5
LSV measured values at different potentials

| | | | Potential applied (V) | | | |
|---|---|---|---|---|---|---|
| | | 0 | 0.2 | 0.4 | 0.6 | 0.8 |
| Substrate | Electrode | Current density (A m⁻²) | | | | |
| Acetate | CC | 10.15 | 15.37 | 19.37 | 19.43 | 18.95 |
| | CCB | 3.14 | 6.92 | 11.19 | 15.74 | 17.00 |
| | CCA | 3.90 | 6.82 | 11.00 | 14.74 | 14.75 |
| | CCAB | 6.02 | 10.38 | 14.99 | 16.43 | 16.14 |
| Acetate:WW | CC | 5.82 | 7.45 | 8.24 | 9.00 | 9.48 |
| (2:1) | CCB | 2.84 | 4.44 | 5.85 | 6.46 | 7.42 |
| | CCA | 3.58 | 5.59 | 7.05 | 7.82 | 8.17 |
| | CCAB | 4.80 | 8.36 | 8.20 | 8.311 | 8.59 |
| Acetate:WW | CC | 1.50 | 1.47 | 1.36 | 1.66 | 2.26 |
| (1:1) | CCB | 0.85 | 2.61 | 3.59 | 2.99 | 2.96 |
| | CCA | 2.19 | 3.49 | 3.79 | 3.50 | 3.42 |
| | CCAB | 4.09 | 3.85 | 3.85 | 4.02 | 4.27 |
| WW | CC | 0.47 | 2.47 | 4.71 | 5.46 | 5.80 |
| | CCB | 0.76 | 1.90 | 3.28 | 4.99 | 7.12 |
| | CCA | 3.53 | 5.45 | 7.65 | 10.87 | 14.82 |
| | CCAB | 4.89 | 7.45 | 9.21 | 10.27 | 10.93 |

### Hydrogen Formation in the MECs Based on the Immobilized Bacterial Anodes (CCB, CCA, CCAB) and the Non-Immobilized Anode (CC)

The effect of the immobilized bacterial anodes (CCB, CCA, CCAB) and the non-immobilized anode (CC) on the rate of hydrogen formation was examined when the different MECs were in a complete cell (2-electrode configuration).

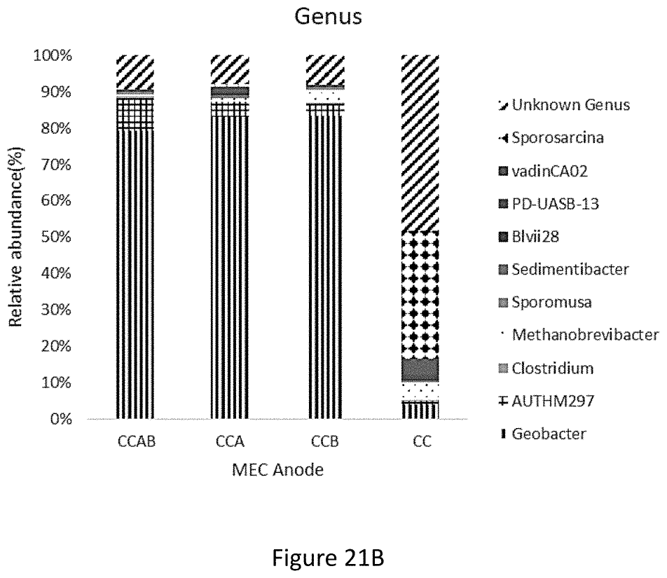

LSV steady-state polarization was observed for the cathode in MECs with acetate (FIG. 20A) and WW (FIGS. 20B-D). The results depicted in FIG. 20A show that the highest reduction current (6.99 A m⁻² at an applied cell voltage of 0.8V) was obtained in the MEC with the non-immobilized CC anode in the presence of acetate. However, when WW was added, the CCAB bacterial anode led to the highest reduction current (WW: acetate at a ratio of 2: 1; 1:1 and only WW) of 8.66 A m⁻², 4.44 A m² and 4.14 A m⁻², respectively (FIG. 20B).

TABLE 6
Hydrogen production rates at 0.8 V with standard deviations

| | Substrate | | | | | | | |
|---|---|---|---|---|---|---|---|---|
| | Acetate | | WW(2:1) | | WW(1:1) | | WW | |
| | Potential | | | | | | | |
| Anode | 0.8 V | | | | | | | |
| type in | | H₂ | | H₂ | | H₂ | | H₂ |
| MEC | mA | (m³/d/m³) | mA | (m³/d/m³) | mA | (m³/d/m³) | mA | (m³/d/m³) |
| CC | 4.37 | 0.66 ± 0.034 | 2.83 | 0.43 ± 0.178 | 1.25 | 0.19 ± 0.016 | 0.88 | 0.13 ± 0.013 |
| CCB | 3.20 | 0.48 ± 0.0355 | 1.87 | 0.28 ± 0.174 | 1.96 | 0.30 ± 0.008 | 1.09 | 0.16 ± 0.012 |
| CCA | 2.31 | 0.35 ± 0.143 | 2.53 | 0.38 ± 0.144 | 1.59 | 0.24 ± 0.596 | 1.82 | 0.28 ± 0.140 |
| CCAB | 4.00 | 0.61 ± 0.142 | 5.41 | 0.82 ± 0.143 | 2.77 | 0.42 ± 0.594 | 2.58 | 0.39 ± 0.141 |

HER rates per cubic meter of anodic medium, with acetate as the carbon source at an applied voltage of 0.8V were 0.66, 0.48, 0.35 and 0.61 m³m⁻³d⁻¹; and with raw WW, 0.13, 0.16, 0.28 and 0.39 m³m⁻³d⁻¹, CC, CCB, CCA and CCAB, respectively (Table 6).

In summary, when the MECs were fed with acetate, the MEC based on the non-immobilized CC anode resulted in the most top hydrogen production (0.9 times higher than the CCAB bacterial anode). However, when raw WW was used as a carbon source, the hydrogen production in the MEC using the CCAB bacterial anode was the highest (3.0 times higher than that of the non-immobilized CC anode).

### Bacterial Diversity Analysis

As can be depicted from FIG. 3, the most abundant phyla of the different encapsulated anode (CCAB, CCA, and CCB) are the Proteobacteria with relative distribution of 79% to 84%, but only 6% in the non-encapsulated CC anode. Remaining phyla (Thermotogae, Acidobacteria, Firmicutes, etc.,) were 15% in the immobilized anodes.

The most dominant phyla in MEC with the CC anode are Firmicutes (43.47%), Bacteroidetes (21.37%), unknown phylum (14.62%), remains phyla were Euryarchaeota (7.77%), Proteobacteria (6.61%), Synergistetes (5.09%) and Thermotogae (0.95%) were observed.

The proportion of genera Geobacter in MEC reactors of CCAB, CCB, and CCA anodes around 81-85%. CC MEC reactor Geobacter bacteria accounted for only 4% of the microbial population. Another major genus are AUTHM297 (9.13%, 4.24%, 3.42%) and Unknown Genus (9.12%, 7.82%, 7.94%) were observed in immobilized anodes. In the case of non-immobilized anodes Sporosarcina (36%), Unknown genus (50%), Methanobrevibacter (5%) mainly observed. The relative abundance of Methanobrevibacter in the CC reactor reached 5.02%. In the case of CCAB, CCA reactors are only 0.45% and 0.95%, respectively. AUTHM297 was found in the anodic biofilm of CCAB, CCB, CCA and CC with 9.13%, 4.24%, 3.42% and 1.13%, respectively. As a result, this study observed higher H2 production. Therefore hydrogen production was high in CCAB, CCB reactors at +0.8V.

### COD Removal

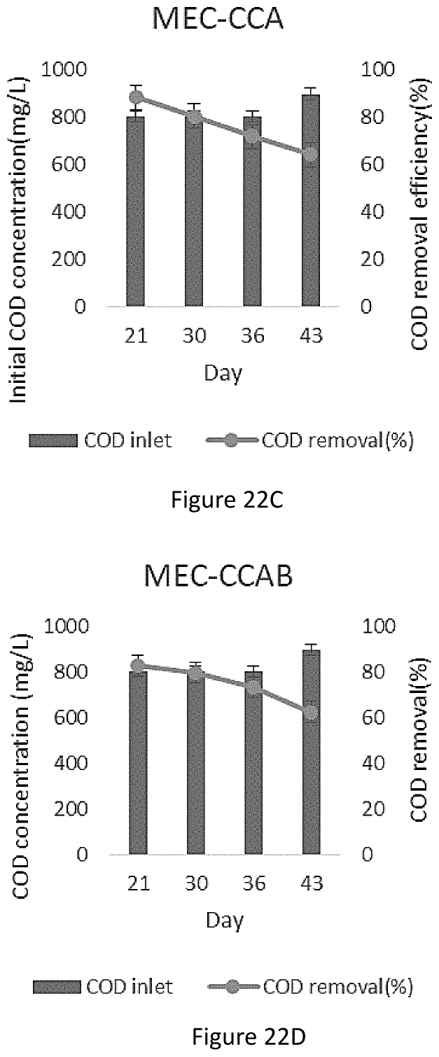

An initial acetate COD of 800 mg/L was fed to all the bioreactors and evaluated at end of experiment cycle (4 days) to assess the impact of the bioanode on substrate degradation. In CC, CCB bio anodes removal efficiency (RE) was 93%, in CCA bioanodes RE was 88% and CCAB bioanode RE was 83%. It indicates CC and CCB bioanodes were showing highest RE with acetate. CCA and CCAB bioanodes were showing less RE compared to CC, CCB bioanodes. The COD removal with acetate: WW (2:1) was observed to be lower in CC bioanodes (68%), followed by CCAB (79%), CCA (80%) and CCB (82%) (FIGS. 22A-D). It indicates immobilized bioanodes are showing higher RE compared to control bioanodes because of immobilized bioanodes have capacity of robustness. The COD removal with acetate: WW (1:1) was observed to be higher in bioanodes of CC (88%) bioanode, CCB (82%), CCA (71%), CCAB (73%). Finally, with WW higher COD RE was observed with CCB (83%), CC (72%), CCB (64%) and CCAB (62%) with initial COD of 896 mg/L. In this stage in immobilized bioanodes depicts lower COD RE compared to control bioanodes, attributed to increased concentration of planktonic cells. Moreover, hydrogen evolution was higher by 48%, 55%, and 66% with acetate:WW (2: 1), acetate: WW (1:1), raw WW in immobilized CCAB anode MECs, assisted by a more active electrogenic biofilm imbedded in the alginate matrix covering the anodes. The results are summarized in Table 7.

TABLE 7
COD removal efficiency (RE) in the MECs based on the CC, CCB, CCA and CCAB anodes

| | Inlet | CC-Final | CC-COD | CCB-Final | CCB-COD | CCA-Final | CCA-COD | CCAB-Final | CTAB-COD |
|---|---|---|---|---|---|---|---|---|---|
| Substrate | COD (mg/L) | COD (mg/L) | RE (%) | COD (mg/L) | RE (%) | COD (mg/L) | RE (%) | COD (mg/L) | RE (%) |
| Acetate | 800 | 49 | 93.875 | 50 | 93.75 | 95 | 88.125 | 136 | 83 |
| WW(2:1) | 800 | 250 | 68.75 | 139 | 82.625 | 157 | 80.375 | 163 | 79.625 |
| WW(1:1) | 800 | 96 | 88 | 139 | 82.625 | 225 | 71.875 | 214 | 73.25 |
| WW | 896 | 250 | 72.09821 | 151 | 83.14732 | 321 | 64.17411 | 336 | 62.5 |

### Example 21

Bacterial Anode Comprising a Catalyst

### Methods

### Preparation of Fe—Mn—C Catalyst and Coating on Plasma-Treated Carbon Cloth

Initially, 0.4 g Catechol was dissolved in 20 mL dichloroethane solvent. To it dimethoxymethane (0.68 mL) was added slowly and stirred for 10 min; 1.2 g anhydrous FeC13 was then added to this stirred solution and further stirred for 20 h at 90° C. A brown precipitate appeared, filtered and thoroughly washed with methanol, water, and ethanol until the filtrate became colorless. The obtained product (MOP) was dried at 60° C. overnight, which was collected (0.1 g) and mixed with 0.05 g Manganese (II) acetate tetrahydrate in a beaker containing 1:1 mixture of water and isopropanol (by volume). The mixture was stirred to allow interaction and adsorption of manganese salt into the MOP matrix. After 12 h, the solvent was removed by heating at 60° C. The dried mixture of manganese and iron containing material was carbonized according to the above-mentioned procedure. The carbonized product was washed with double-distilled water and dried overnight at 60° C. The final product was identified as CFeMn.

The synthesized CFeMn (40% of FeMn) catalyst was dissolved in water and nafion (5%) mixture with the final concentration of 0.5 mg/cm² of the anode. Thereafter sonicated for 30 minutes, the sonicated complex mixture was applied on to the plasma-treated carbon cloth by using a micro pipet and air-dried at room temperature.

### MEC Experimental Procedure

A single-chamber MEC was constructed using glass bottles with a total volume of 100 ml and 90 ml working volume. Platinum (Pt-0.5 mg cm⁻²) coated carbon cloth (1 cm×1 cm) was used as a cathode, plasma treated carbon cloth or CFeMn catalyst coated plasma-treated carbon cloth was used as an anode and Ag/AgCl electrode was used as a reference electrode. The MECs were filled with Geobacter medium containing sodium acetate (10 mM) (800 mg/L COD) as the carbon source. The bottles were sealed with a screw cap and GL-45 silicone rubber septa stoppers. The MECs were incubated at a temperature of 35° C. The MEC cells were placed on a magnetic stirrer for constant electrolyte stirring at 120 rpm. The duration of the experiment is 30 days, to provide adequate time for the development of bacteria and the investigation of bioelectrochemical activities.

A total of 3 sets of experiments planned using different anodes, with and without catalyst with and without bacteria. The first set of experiments are catalyst coated plasma-treated carbon cloth as an anode without bacteria (CC-femn). In the second set of experiments, catalyst coated plasma-treated carbon cloth as an anode along with G. Sulferreducens bacteria (CC-femn-B). In the third set of experiments, plasma-treated carbon cloth as an anode along with G. Sulferreducens bacteria (CC-B) and all the three experiments were run quadruplicates to obtain repeatability of the results.

### Results

Hydrogen production in MECs is mostly related to the bacterial anode activity. The limitations of the anode are attributed to the bacterial attachment, biofilm development, and handling of electroactive biofilm for a prolonged period and conductivity. The anode material should be highly conductive, support the biofilm attachment, be chemically stable and cost-effective.

In this study, we examined a new concept of FeMn catalyst doped carbon cloth of anode material with Geobacter sulfurreducens (CC-femn-B) was compared to the FeMn catalyst doped carbon cloth of anode material without Geobacter (CC-femn) and plasma-treated carbon cloth of anode material with Geobacter sulfurreducens (CC-B).

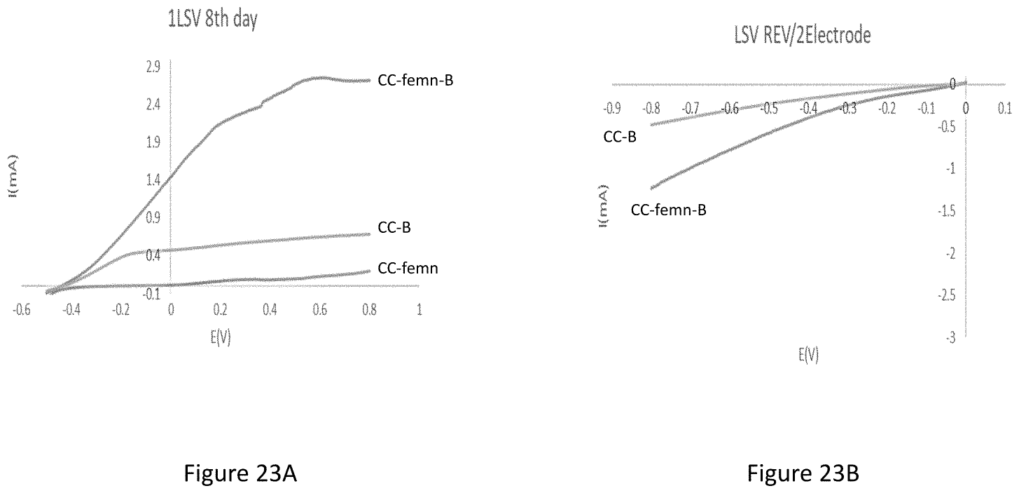

Linear sweep voltammetry (LSV) measurements were performed (FIGS. 23A-B).

MEC applying FeMn catalyst doped carbon cloth with Geobacter (CC-femn-B) produced higher currents compared to MECs based on FeMn catalyst doped carbon cloth without bacteria (CC-femn) and higher than plain carbon cloth anodes without catalysts (CC-B).

Under an applied voltage of 0.6V vs. Ag/AgCl, the currents obtained in a MEC based on CC-femn-B was 2.75 mA, compared to MEC with CC—FeMn and CC-B which produced low currents of 0.13 mA and 0.65 mA, respectively.

In the following experiments, the electrochemical currents were measured in potentiosat driven MEC, connected by two electrodes configuration. The results depicted in FIG. 1b, show that the highest hydrogen reduction current obtained in MEC in the FeMn catalyst doped carbon cloth with Geobacter (CC-femn-B). At the maximal applied cell voltage (0.8V) the obtained reduction current in MEC based on CC-femn-B anode was 1.23 mA while in MEC based on CC-femn and CC-B reduction current were 0.05 mA and 0.48 mA, respectively.

### SEM Analysis

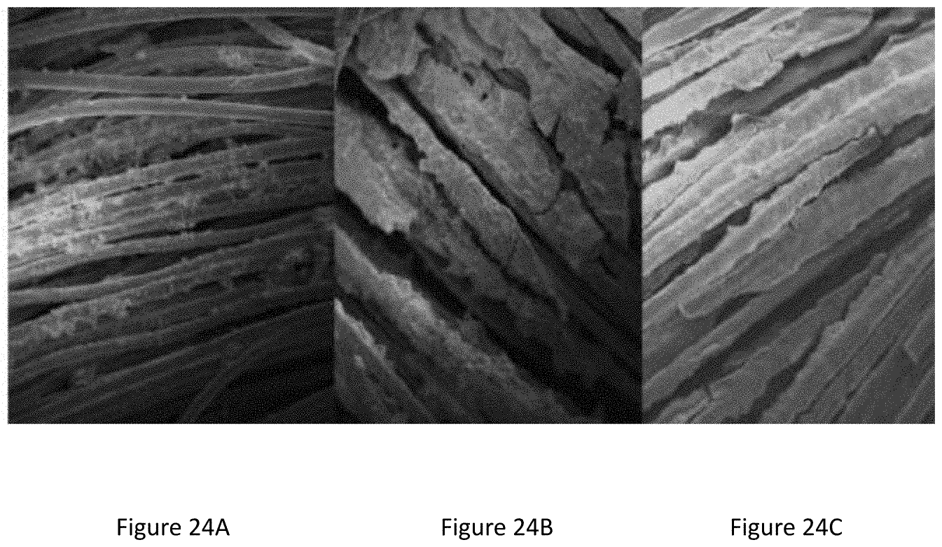

The FeMn catalyst doped plasma-treated carbon cloth (before the experiment) (FIG. 24A) and anode biofilms (after the experiment) were examined with a scanning electron microscope (FIGS. 24A-C). The FeMn catalyst doped carbon cloth (before the experiment) was showed doped FeMn particles on carbon cloth and EDX revealed that Fe and Mn percentage were 7.2% and 92.1 5, respectively. The anode biofilms with FeMn catalyst doped carbon cloth with Geobacter (CC-femn-B) and carbon cloth anodes with Geobacter (CC-B) showed very good uniformly grown biofilms were observed in both the cases after the experiment. In these two biofilm anodes, EDX was not detected any Fe or Mn. It is attributed to FeMn catalyst covered with biofilm. So, EDX probe was unable to detect these metal complexes in CC-femn-B anode and CC-B anode. The developed biofilm on CC-femn-B anode transported electrons efficiently within the anode biofilm and it could be helped to produce higher energy output in the MEC. In the case of CC-B anode (FIG. 24 B), Biofilm was looked like CC-femn-B (FIG. 24C) anode biofilm, but the current output was less compared to CC-femn-B anode. It depicts the FeMn complex is playing a crucial role in higher energy output, either by improved electrocatalytic reaction rate or by providing trace elements from the catalyst to be consumed by the biofilm to expedite the bacterial growth or more pile formation.

### Example 22

Current Production in Microbial Fuel Cell Based on Immobilized Anode Using a Mineral

The MFC comprised a dual-glass chamber separated by a proton-selective membrane (Nafion® 115; Ionpower, USA). The volume of each chamber was 250 ml. The anode chamber contained 150 ml Geobacter medium and 50 ml PB pH 6.8 (50 mM final concentration), carbon cloth bacterial anode and Ag/AgCl reference electrode. The cathode chamber contained 200 of 50 mM PB pH 6.8, and Pt catalyst coated carbon cloth (0.5 mg catalyst/cm²). All parts were autoclaved prior to each experiment, except for the reference electrode, which was rinsed with 70% ethanol followed by distilled water. The anode and the cathode were connected through an external 1000Ω resistor (Resistance Decade Box 72-7270, Tenma, USA). The MFC was placed in a thermostatic bath at 30° C. and the anode chamber was agitated slowly using a magnetic stir bar. The cathode chamber was aerated through a 0.45-mm-pore-size filter (Whatman, USA) to maintain an oxygenated environment while preventing contamination.

In each of the MFCs the anode was made of carbon cloth pretreated with cold nitrogen plasma (to increase hydrophilicity). Three MFC were constructed which were differentiated by the induced material to the anode compartment: 1-kaolin (2.5 g); 2-kaolin (2.5 g) as well as graphite particles (0.25 g) (conductive material to increase electron transfer from the bacteria to the anode material); 3-kaolin (2.5 g) as well as activated carbon (0.25 g) (same explanation as for graphite). The control MFC was based on only carbon cloth anode without addition of the above materials.

The anode chamber of all the 4 MFCs was supplied with Geobacter (0.1 OD final turbidity) and acetate (20 mM).

LSV measurements in MFCs based on the different anodes was performed using MultiEmStat3+(Palmsens, Netherlands with scan rate of 2 mV/s. It is important to indicate that during the MFCs operation, the kaolin in the liquid environment became as a glue which led to increase the bacterial attachment as well as the conductive materials (activated carbon and graphite particles). The layer of the mentioned combination could be seen by naked eyes.

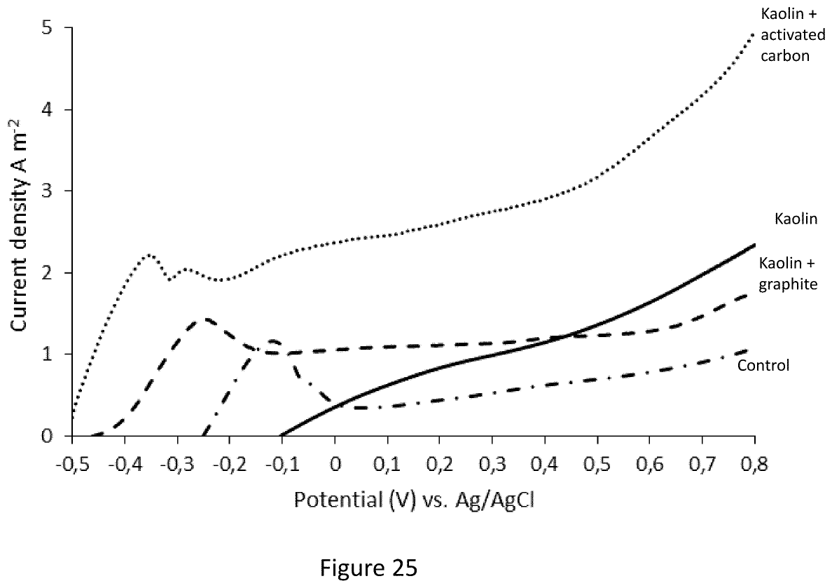

The results in FIG. 25 show that the highest current density was obtained in the MFC which was based on kaolin with activated carbon. At 0.6V the kaolin with activated carbon led to 3.66 A m⁻², the kaolin with graphite particles led to 1.28 A m⁻², the kaolin 1.64 A m⁻² and the control anode led to only 0.78 A m⁻².

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1. An anode comprising:
(i) a conductive material;
(ii) a bacteria; and
(iii) a polymer, a catalyst, a mineral, or any combination thereof;
wherein said bacteria and said polymer, said catalyst, said mineral, or any combination thereof, are deposited on at least one surface of said anode.

2. (canceled)

3. (canceled)

4. (canceled)

5. The anode of claim 1, comprising 0.1 mg/cm² to 10 mg/cm² of said catalyst.

6. The anode of claim 1, wherein said catalyst comprises iron, manganese, vanadium, chromium, tungsten, tin, lead, bismuth, copper, nickel, silver, gold, titanium, platinum, palladium, iridium, ruthenium, molybdenum and their oxides, carbides, sulfides, selenides, phosphides, or any combination thereof.

7. The anode of claim 1, comprising 0.5 g to 5 g of said mineral.

8. The anode of claim 1, wherein said mineral comprises Kaolin, Smectite, Chlorite, Halloysite, Dickite, Montmorillonite Magnetite, Ilmenite, Hematite, or any combination thereof.

9. The anode of claim 1, comprising a permeable mesh as an outer layer.

10. The anode of claim 9, wherein said permeable mesh is selected from the group consisting of: polyamide, cellulose, cellulose ester, polysulfone, polyethersulfone (PES), etched polycarbonate, and collagen.

11. The anode of claim 1, wherein the ratio of said polymer and said conductive material is 0.1:1 to 1:0.1.

12. The anode of claim 1, wherein said bacteria is an exoelectrogenic bacteria selected from Geobacteraceae, Aeromonadaceae, Alteromonadaceae, Clostridiaceae, Comamonadaceae, Desulfuromonaceae, Enterobacteriaceae, Pasturellaceae, and Pseudomonadaceae.

13. The anode of claim 1, wherein said polymer comprises alginate, chitosan, agarose, kaolin, polyvinyl pyridine, poly ethers, poly vinyl alcohol, or any combination thereof.

14. The anode of claim 1, wherein said polymer comprises alginate and chitosan at a ratio of 0.1:1 to 1:0.1.

15. The anode of claim 1, wherein said conductive material comprises a redox polymer, carbon nanotube (CNT), graphene, activated carbon, carbon paper, carbon cloth, carbon felt, carbon wool, carbon foam, graphite, porous graphite, graphite powder, graphite granules, graphite fiber, a conductive polymer, metal, metal-porpherine, metal-corolles, metal-selens, quinone, organic dye, and any combination thereof.

16. A microbial electrochemical system comprising the anode of claim 1, and a cathode.

17. (canceled)

18. (canceled)

19. The microbial electrochemical system of claim 16, characterized by hydrogen evolution reaction (HER) rate in the range of 0.1 m³·m⁻³·d⁻¹ to 5 m³·m⁻³·d⁻¹.

20. The microbial electrochemical system of claim 16, characterized by chemical oxygen demand (COD) removal in the range of 70% to 90%.

21. The microbial electrochemical system of claim 16, characterized by current density in the range of 2 A·m⁻² to 30 A·m⁻².

22. A method for wastewater (WW) treatment, hydrogen production, electricity generation, or any combination thereof, the method comprising:
(i) providing the microbial electrochemical system of claim 16;
(ii) contacting said microbial electrochemical system with a carbon source; and
(iii)_providing a current density to said microbial electrochemical system.

23. (canceled)

24. The method of claim 22, wherein
said carbon source comprises wastewater, acetate, or a combination thereof.

25. The method of claim 22, wherein said carbon source comprises acetate and wastewater at a ratio of 5:1 to 0.5:1.

26. The method of claim 22, characterized by a COD of 800 mg/L to 1000 mg/L.

27. (canceled)

28. (canceled)

29. (canceled)
